(19) United States
(12) Patent Application Publication
(10) Pub. No.: US 2019/0354114 A1
(43) Pub. Date: Nov. 21, 2019

(54) Selective Activation of Autonomous Vehicles

(71) Applicant: Uber Technologies, Inc., San Francisco, CA (US)

(72) Inventors: Brent Justin Goldman, San Francisco, CA (US); Leigh Gray Hagestad, San Francisco, CA (US); Rei Chiang, San Francisco, CA (US); Christopher James Lyons, Oakland, CA (US)

(21) Appl. No.: 16/414,144

(22) Filed: May 16, 2019

Related U.S. Application Data
(60) Provisional application No. 62/672,245, filed on May 16, 2018.
(60) Provisional application No. 62/729,071, filed on Sep. 10, 2018.

(51) Int. Cl. G05D 1/02; G08G 1/00; G06Q 30/02; G06Q 50/30

(52) U.S. Cl. CPC G05D 1/0297; G08G 1/207; G05D 2201/0213; G06Q 50/30; G06Q 30/0205

(57) ABSTRACT

Systems and methods for controlling autonomous vehicle activation are provided. In one example embodiment, a computing system can obtain data associated with an autonomous vehicle that is offline with a service entity. The computing system can obtain data indicative of a geographic area associated with the service entity. The computing system can determine that the autonomous vehicle is to go online with the service entity within the geographic area based at least in part on the data associated with the autonomous vehicle and the data indicative of the geographic area. The computing system can communicate data indicative of an activation assignment associated with the autonomous vehicle. The activation assignment can be indicative of at least a portion of the geographic area within which the autonomous vehicle is to go online with the service entity.

### PRIORITY CLAIM

The present application is based on and claims priority to U.S. Provisional Application 62/672,245 having a filing date of May 16, 2018, and U.S. Provisional Application 62/729,071 having a filing date of Sep. 10, 2018, all of which are incorporated by reference herein.

### FIELD

The present disclosure relates generally to controlling the activation of autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can navigate through such surrounding environment.

### SUMMARY

Aspects and advantages of embodiments of the present disclosure will be set forth in part in the following description, or may be learned from the description, or may be learned through practice of the embodiments.

One example aspect of the present disclosure is directed to a computing system. The computing system includes one or more processors and one or more tangible, non-transitory, computer readable media that collectively store instructions that when executed by the one or more processors cause the computing system to perform operations. The operations include obtaining data associated with an autonomous vehicle that is offline with a service entity. The operations include obtaining data associated with a geographic area associated with the service entity. The operations include determining that the autonomous vehicle is to go online with the service entity within the geographic area based at least in part on the data associated with the autonomous vehicle and the data associated with the geographic area. The operations include communicating data indicative of an activation assignment associated with the autonomous vehicle. The activation assignment is indicative of at least a portion of the geographic area within which the autonomous vehicle is to go online with the service entity.

Another example aspect of the present disclosure is directed to a computer-implemented method for controlling autonomous vehicle activation. The method includes obtaining, by a computing system that includes one or more computing devices, data associated with one or more autonomous vehicles that are offline with a service entity. The method includes obtaining, by the computing system, data associated with one or more geographic areas associated with the service entity. The method includes determining, by the computing system, a first geographic area within which a first autonomous vehicle is to go online with the service entity and a first time parameter indicative of a time at which the first autonomous vehicle is to go online with the service entity based at least in part on the data associated with the one or more autonomous vehicles and the data associated with the one or more geographic areas. The method includes communicating, by the computing system, data indicative of a first activation assignment associated with the first autonomous vehicle. The first activation assignment is indicative of at least a portion of the first geographic area and the first time parameter.

Yet another example aspect of the present disclosure is directed to one or more tangible, non-transitory, computer-readable media that collectively store instructions that, when executed by one or more processors, cause the one or more processors to perform operations. The operations include obtaining data associated with a plurality of autonomous vehicles that are offline with a service entity. The operations include obtaining data indicative of a geographic area associated with the service entity. The operations include determining that at least a subset of the plurality of autonomous vehicles are to go online with the service entity within the geographic area based at least in part on the data associated with the plurality of autonomous vehicle and the data indicative of the geographic area. The operations include communicating data indicative of one or more activation assignments associated with at least the subset of the plurality of autonomous vehicles. The one or more activation assignments are indicative of at least a portion of the geographic area.

Other example aspects of the present disclosure are directed to systems, methods, vehicles, apparatuses, tangible, non-transitory computer-readable media, and memory devices for controlling the positioning and timing of the activation of autonomous vehicles with a service entity.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example autonomous vehicle computing system according to example embodiments of the present disclosure;

FIG. 2 depicts example service entity network(s) for an autonomous vehicle according to example embodiments of the present disclosure;

FIG. 3 depicts an example operations computing system of a service entity according to example embodiments of the present disclosure;

FIG. 4 depicts example geographic areas according to example embodiments of the present disclosure;

FIG. 5 depicts a flow diagram of an example method for autonomous vehicles activation according to example embodiments of the present disclosure; and

FIG. 6 depicts example system components according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to improved techniques for decreasing potential idle data usage and downtime of an autonomous vehicle. For instance, an autonomous vehicle can be utilized to perform vehicle services (e.g., transportation services, etc.). The vehicle services can be offered to users by a service entity (e.g., a company that offers and coordinates the provision of vehicle services). An autonomous vehicle can be activated to go online with the service entity's network to become available to perform the vehicle service(s) of that service entity by obtaining vehicle service assignments (e.g., trip requests) from the service entity. However, once the autonomous vehicle goes online, there may be a delay until the autonomous vehicle receives a vehicle service assignment from the service entity. When it is not addressing a vehicle service assignment, an autonomous vehicle can be in an idle state. Even in the idle state, an autonomous vehicle can continue to acquire sensor data to remain cognizant of its environment (e.g., whether the vehicle is parked, moving, etc.). This can cause the autonomous vehicle to waste its processing, data storage, and power resources while it is not performing a vehicle service and, ultimately, increase vehicle downtime (e.g., as the vehicle is forced to travel to a service depot for data downlinking, re-charging, etc.).

The systems and methods of the present disclosure can help strategically position autonomous vehicles while they are offline in order to reduce the potential for such resource waste. For instance, a computing system (e.g., of a service entity) can identify an autonomous vehicle that is offline with a service entity. The computing system can identify a geographic area that is predicted to experience an imbalance in a number of vehicles associated with the geographic area. The imbalance can be a deficit in the number of vehicles that are available to perform vehicle services as compared to a demand for the vehicle service(s). The computing system can instruct the autonomous vehicle to re-position itself to the imbalanced geographic area while the autonomous vehicle is offline. Moreover, the computing system can indicate a time at which the autonomous vehicle is to go online with the service entity. This time can correspond to a future time when the geographic area is predicted to experience the vehicle imbalance. In this way, the autonomous vehicle can be re-positioned while it is offline so that it is more likely to receive vehicle service assignments when it is activated with the service entity, thereby reducing the amount of potential idle data usage and vehicle downtime.

More particularly, an autonomous vehicle (e.g., ground-based vehicle, etc.) can include various systems and devices configured to control the operation of the vehicle. For example, an autonomous vehicle can include an onboard vehicle computing system (e.g., located on or within the autonomous vehicle) that is configured to operate the autonomous vehicle. The vehicle computing system can obtain sensor data from sensor(s) onboard the vehicle (e.g., cameras, LIDAR, RADAR, etc.), attempt to comprehend the vehicle's surrounding environment by performing various processing techniques on the sensor data, and generate an appropriate motion plan through the vehicle's surrounding environment. Moreover, an autonomous vehicle can include a communications system that can allow the autonomous vehicle to communicate with a computing system that is remote from the autonomous vehicle such as, for example, that of a service entity.

An autonomous vehicle can perform vehicle services for one or more service entities. A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via a software application (e.g., on a user computing device), via a website, and/or via other types of interfaces that allow a user to request a vehicle service. The vehicle services can include user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services. In some implementations, a service entity can utilize non-autonomous vehicles (e.g., human-driven vehicles) to perform one or more of its vehicle services.

The service entity can utilize an operations computing system to coordinate one or more vehicles (e.g., non-autonomous vehicles, autonomous vehicles, etc.) to perform vehicle services for a user. For instance, the user can provide (e.g., via a user device) a request for a vehicle service to an operations computing system associated with the service entity. The request can indicate the type of vehicle service that the user desires (e.g., a user transportation service, a delivery service, a courier service, etc.), one or more locations (e.g., an origin, destination, etc.), timing constraints (e.g., pick-up time, drop-off time, deadlines, etc.), a number of user(s) and/or items to be transported in the vehicle, other service parameters (e.g., a need for handicap access, handle with care instructions, etc.), and/or other information. The operations computing system of the service entity can process the request and generate a vehicle service assignment indicative of the requested vehicle service (e.g., type of service, associated user(s), location(s), timeframe(s), etc.).

The operations computing system can identify one or more vehicles that may be able to accept the vehicle service assignment and perform the requested vehicle services for the user. For instance, the operations computing system can identify which autonomous vehicle(s) are online with the service entity. An autonomous vehicle can go online with a service entity such that the autonomous vehicle is available to perform the vehicle service(s) of the service entity (e.g., available to obtain/accept vehicle service assignment(s)). For example, the vehicle computing system can launch an onboard vehicle client (e.g., software, firmware, etc.) associated with the service entity and open a communication session with the service entity's operations computing system. The vehicle computing system can communicate that the autonomous vehicle is available to perform a vehicle service for the service entity via the communication session (e.g., using an API associated with the service entity). Alternatively, an autonomous vehicle can be offline with a service entity such that the autonomous vehicle is unavailable to perform the vehicle service(s) of the service entity (e.g., unavailable to obtain/accept vehicle service assignment(s)). While offline, however, an autonomous vehicle may still be capable of obtaining information from a service entity, as further described herein.

A service entity may have varying levels of control over the autonomous vehicles that perform its vehicle services. In some implementations, an autonomous vehicle can be included in the service entity's dedicated supply of autonomous vehicles. The dedicated supply can include autonomous vehicles that are owned, leased, or otherwise exclusively available to the service entity (e.g., for the provision of its vehicle service(s), other tasks, etc.) for at least some period of time. This can include, for example, an autonomous vehicle that is associated with a third party vehicle provider (e.g., an owner, a manufacturer, a vendor, a manager, a coordinator, a handler, etc.), but that is online only with that service entity (e.g., available to accept vehicle service assignments for only that service entity) for a certain time period (e.g., a day, week, etc.). In some implementations, an autonomous vehicle can be included in the service entity's non-dedicated supply of autonomous vehicles. This can include autonomous vehicles that are not exclusively available to the service entity. For example, an autonomous vehicle that is concurrently online with two different service entities so that the autonomous vehicle may accept vehicle service assignments from either service entity may be considered to be part of a non-dedicated supply of autonomous vehicles. In some implementations, whether an autonomous vehicle is considered to be part of the dedicated supply or the non-dedicated supply can be based, for example, on an agreement between the service entity and a vehicle provider associated with the autonomous vehicle.

A service entity can seek to decrease the amount of time that an autonomous vehicle may be idle when the autonomous vehicle initially goes online with the service entity. To do so, the operations computing system can obtain data associated with autonomous vehicle(s) that are offline with the service entity. These can be autonomous vehicle(s) that are a part of the service entity's dedicated supply or non-dedicated supply. Moreover, these can be autonomous vehicle(s) that are included in the vehicle fleet of a vehicle provider. The data associated with these offline autonomous vehicle(s) can be indicative of: an autonomous vehicle's current and/or future planned location (e.g., where the autonomous vehicle is parked while offline, where the autonomous vehicle is scheduled to be when it goes online, etc.), the vehicle provider associated with an autonomous vehicle, a preference of the vehicle service(s) that an autonomous vehicle is configured to perform, whether the autonomous vehicle is included in the dedicated or non-dedicated supply of the service entity, one or more geographic constraints (e.g., restrictions on where an autonomous vehicle can travel), an autonomous vehicle's performance rating (and/or the rating of an associated vehicle provider), a configured preference of an autonomous vehicle to participate in vehicle service pooling, one or more vehicle characteristics of an autonomous vehicle (e.g., make, model, type, shape, size, etc.), and/or other information. The operations computing system can utilize this data to identify which autonomous vehicles are available for offline re-positioning, to help reduce the potential for the autonomous vehicle to waste its resources when it goes online (e.g., while in an idle state).

To help determine where an autonomous vehicle may be re-positioned, the service entity's operations computing system can obtain data associated with one or more geographic areas. These can be geographic areas associated with the service entity (e.g., area(s) in which the service entity offers vehicle service(s), area(s) in which previous vehicle service assignments have been completed, area(s) in which future vehicle service requests are predicted, etc.). The data associated with a geographic area can be indicative of, for example, the past, present, and/or future (e.g., known and/or predicted): demand for vehicle services associated with the geographic area (e.g., the number of service requests that begin, end, have an intermediate location within, and/or involve the traversal of the geographic area, etc.), the supply of vehicles within the geographic area (e.g., the number of non-autonomous vehicles, the number of autonomous vehicles, etc.), events associated with the geographic area (e.g., concerts, sporting events, performances, etc.), a utilization rate of autonomous vehicles within the geographic area, weather conditions associated with the geographic area (e.g., rain, snow, high/low temperatures, etc.), and/or other information. In some implementations, the operations computing system can utilize past and/or current data to project future parameters associated with the geographic area. For example, the operations computing system can predict a future demand for vehicle services within the geographic area based at least in part on a past and/or current demand for vehicle services with like circumstances (e.g., similar time of day, season, occurrence, weather, etc.). The data associated with the geographic area can also be indicative of whether autonomous vehicles are permitted and/or capable of operating within the area. In some implementations, the data associated with the geographic area can be indicative of one or more conditions imposed on non-autonomous vehicles (e.g., service conditions imposed by the service entity within the area, etc.). This can include, for example, constraints on the types of vehicle services that non-autonomous vehicles can provide and/or constraints on the geographic boundaries within which the non-autonomous vehicles can travel. In some implementations, the data associated with the geographic area(s) can include time specific information associated with a geographic area. The time specific information can indicate, for example, times at which it may be difficult for an autonomous vehicle to operate within the geographic area (e.g., power blackouts typically occur between 12 AM to 5 AM, etc.).

The operations computing system can identify which geographic area(s) have a vehicle imbalance based at least in part on the collected data associated with the geographic area(s). This can include a present and/or future imbalance in the number of vehicles associated with the geographic area. The vehicles associated with a geographic area can be vehicles that are available to perform vehicle service(s) that begin, traverse, and/or end within the geographic area. This can include non-autonomous vehicles and/or autonomous vehicles. The vehicle imbalance can include, for example, a surplus or a deficit in the number of vehicles (e.g., non-autonomous vehicles and/or autonomous vehicles) as compared to a demand for the one or more vehicles services. The operations computing system can determine that a geographic area has an imbalance in the number of vehicles associated with the geographic area based at least in part on the data associated with the geographic area. By way of example, the operations computing system can determine that there should be an increase in the number of vehicles within the geographic area in the event that the current and/or future demand for vehicle service(s) outweighs the current and/or future supply of vehicles within the geographic area (e.g., a deficit). As such, these geographic areas represent opportunities of where the supply of autonomous vehicles can be adjusted to increase the opportunity for an autonomous vehicle to receive vehicle service assignments.

The operations computing system can determine where an offline autonomous vehicle should be activated based at least in part on the data associated with the autonomous vehicle(s) and the data associated with the geographic area(s). Such determination can be made based at least in part on heuristics and/or machine-learned models (e.g., trained to recommend geographic areas and/or autonomous vehicles, etc.). For instance, the operations computing system can determine a first geographic area within which a first autonomous vehicle is to go online with the service entity. The first geographic area can be a geographic area that is predicted to have a vehicle imbalance at a future time. For example, the first geographic area can be an airport facility. The operations computing system can predict that the airport facility will have a deficit in the number of non-autonomous vehicles (e.g., human-driven vehicles) that are within the airport facility as compared to the demand for transportation services. The operations computing system can determine that the supply of non-autonomous vehicles should be supplemented with one or more autonomous vehicles. Thus, the operations computing system can determine that the first autonomous vehicle should travel to the airport facility and then be activated to go online with the service entity (e.g., to obtain vehicle service assignments to transport user(s) from the airport facility).

The operations computing system can select the first autonomous vehicle from among a plurality of autonomous vehicles for the first geographic area. For example, the operations computing system can identify that the first autonomous vehicle is offline with the service entity, is a part of the service entity's dedicated supply, is within proximity of the airport facility area, is an appropriate type of vehicle (e.g., a sport utility vehicle may be more suitable for activation at an airport facility), etc.

In some implementations, the operations computing system can select a geographic area for an autonomous vehicle based on whether (or not) autonomous vehicles can operate in the area. For example, the first geographic area can be an airport facility that is familiar to and/or sufficiently mapped for the first autonomous vehicle. The operation computing system may not select a particular geographic area for the first autonomous vehicle in the event that the particular area is unfamiliar, unmapped, and/or otherwise prohibitive to autonomous vehicle operation.

The operations computing system can also determine when an autonomous vehicle should go online with a service entity. Again, such determination can be made based at least in part on heuristics and/or machine-learned models (e.g., trained to recommend times at which the autonomous vehicles should be activated, etc.). For instance, the operations computing system can determine a first time parameter indicative of when the first autonomous vehicle is to go online with the service entity based at least in part on the data associated with the autonomous vehicle(s) and the data associated with the geographic area(s). The time parameter can be a future point in time at which, or a future time period during which, the first autonomous vehicle is to go online with the service entity. The time parameter can correspond to a time at which the first geographic area is predicted to experience a vehicle imbalance. In various implementations, the time parameter may be unbounded (e.g., open-ended, such as including only a starting time) or bounded (e.g., including a starting time and ending time). By way of example, the operations computing system can predict that the airport facility may experience a deficit in the number of vehicles available to provide transportation services from 8:00 AM to 10:30 AM on a Monday. Accordingly, the operations computing system can determine that the first autonomous vehicle should go online within the airport facility during this time period.

In some implementations, the time parameter can be based at least in part the activation and/or de-activation tendencies of other vehicles. For example, the operations computing system may select a first time parameter such that the first autonomous vehicle goes online with the service entities during a time when other vehicles (e.g., non-autonomous and/or autonomous vehicles) are going offline with the service entity. In this way, the operations computing system can aim to maintain a more consistent supply of vehicles to perform vehicle service(s).

In some implementations, the time parameter can be determined based at least in part on weather conditions associated with the geographic data. For instance, the operations computing system can select a time parameter for the first autonomous vehicle that does not correspond to when the first geographic area is expected to have weather conditions that may affect autonomous vehicle operation (e.g., heavy snowfall, rainfall, etc.). Additionally, and/or alternatively, the time parameter can be determined based at least in part on other time specific information associated with the geographic data. For example, the operations computing system can select a time parameter for the first autonomous vehicle that is outside of a time period that typically experiences blackouts (e.g., which may hinder wireless communication with the first autonomous vehicle).

In some implementations, an autonomous vehicle and/or a vehicle provider can request that an autonomous vehicle be re-positioned while offline. For example, the first autonomous vehicle itself and/or a computing system associated with a vehicle provider (e.g., a vehicle provider computing system) can determine that the first autonomous vehicle will be coming online with the service entity. The autonomous vehicle and/or a vehicle provider computing system can communicate data to the operations computing system, requesting that the first autonomous vehicle be re-positioned while it is offline, so that it has a better opportunity to obtain vehicle service assignments when it goes online.

In some implementations, the operations computing system may select at least a subset of a vehicle provider's fleet to be re-positioned with respect to the geographic area. For example, the operations computing system can determine that a vehicle provider is associated with a plurality of autonomous vehicles that are offline with the service entity. The operations computing system can identify at least a subset of the vehicles in that plurality of autonomous vehicles as potential candidates to be re-positioned with respect to the geographic area while remaining offline. However, the operations computing system may not determine which of those autonomous vehicles are to be re-positioned. Instead, the operations computing system can allow the vehicle provider to determine which of the autonomous vehicles in its offline fleet are to be re-positioned. This can give the vehicle provider the flexibility to determine which vehicle(s) it prefers to re-locate.

To implement its determined offline re-positioning strategy, the operations computing system can communicate one or more activation assignments. The activation assignment(s) can be indicative of the geographic area within which an autonomous vehicle is to go online with a service entity. The activation assignment can indicate that an autonomous vehicle is to arrive at, get as close as possible to, get within a distance of (e.g., a threshold distance of, a reasonable walking distance of, etc.), circle nearby, etc. a location within the geographic area when the autonomous vehicle activates to go online with the service entity. The activation assignment(s) can be indicative of the time parameter, which indicates when the autonomous vehicle should go online with the service entity. As described herein, the time parameter can include at least one of a point in time or a time period at which the autonomous vehicle is to go online with the service entity.

By way of example, the operations computing system can communicate data indicative of a first activation assignment to the first autonomous vehicle. The first activation assignment can indicate that the first autonomous vehicle is to go online within the first geographic area (e.g., the airport facility, etc.) within a particular time and/or within a certain time period (e.g., between 7:45 am-8:15 am, etc.). The first autonomous vehicle may not be currently located within the first geographic area. Thus, the first activation assignment can indicate that the first autonomous vehicle is be re-positioned to the first geographic area (e.g., autonomously travel to the geographic area, etc.) prior to going online with the service entity (e.g., while the first autonomous vehicle is offline). In some implementations, the first activation assignment can include a route for first autonomous vehicle to follow to the first geographic area.

The activation assignment(s) can include a command or a request. For example, an activation assignment can be formulated as a command for the autonomous vehicle(s) that are included in the dedicated supply of the service entity. In some implementations, the command may not be rejected unless the autonomous vehicle is physically impaired from complying. Accordingly, the operations computing system can utilize such commands for the autonomous vehicle(s) that are included in the dedicated supply of the service entity. In some implementations, the activation assignment can be formulated as a request that may be accepted or rejected. For example, the activation assignment can include a request for an autonomous vehicle to re-position to a geographic area while the autonomous vehicle is offline in the event that the autonomous vehicle is included in the non-dedicated supply of the service entity (e.g., the vehicle(s) that have the ability to accept or reject the re-positioning assignment). In some implementations, an activation assignment can include a vehicle service incentive to help entice an acceptance of the activation assignment. The vehicle service incentive can include, for example, an increase in the compensation for the autonomous vehicle's next vehicle service assignment(s), increased rating, priority treatment for vehicle service assignment(s), etc.

The activation assignment(s) can be communicated directly or indirectly to the autonomous vehicle(s). For example, the operations computing system can communicate data indicative of an activation assignment directly to an autonomous vehicle (e.g., via one or more wireless networks, etc.). Additionally, or alternatively, data indicative of an activation assignment can be communicated to a vehicle provider associated with the autonomous vehicle. For example, as described herein, the operations computing system can determine that at least a subset of a vehicle provider's fleet are candidates for offline re-positioning and that it would be satisfied if any of these autonomous vehicles are re-positioned with respect to a geographic area. The operations computing system can communicate data indicative of one or more re-positioning assignment(s) to the vehicle provider's computing system, which can in turn select one or more of its autonomous vehicles to be re-positioned and communicate with those autonomous vehicle(s) accordingly.

In some implementations, the operations computing system can confirm that an autonomous vehicle has undertaken the activation assignment. For example, the operations computing system can obtain data indicating that the first autonomous vehicle is online with the service entity and is located within the first geographic area. Additionally, or alternatively, the operations computing system can determine whether the first autonomous vehicle is autonomously re-positioning itself with respect the geographic area. For example, the operations computing system can obtain data indicative of a vehicle's motion plan to determine whether the first autonomous vehicle intends to travel to the first geographic area as instructed. Additionally, or alternatively, the operations computing system can determine whether the first autonomous vehicle arrived at the first geographic area based at least in part on location data (e.g., GPS data, etc.) associated with the first autonomous vehicle.

The operations computing system can communicate a vehicle service assignment associated with the geographic area to an autonomous vehicle. For instance, after confirming that the first autonomous vehicle has gone online within the first geographic area, the operations computing system can communicate data indicative of a first vehicle service assignment associated with the first geographic area to the first autonomous vehicle. This can include, for example, a request to transport a user from one location within the first geographic area to another. In this way, the operations computing system can make sure that the first autonomous vehicle, which has been re-positioned while offline with the service entity, can obtain a vehicle service assignment while online with the service entity (e.g., reducing idle data usage).

In some implementations, the operations computing system can supplement the supply of autonomous vehicles within a geographic area with one or more non-autonomous vehicles. For instance, in the event that a vehicle imbalance persists within a geographic area, the operations computing system can request that one or more non-autonomous vehicles (e.g., human-driven vehicles) be re-positioned to the geographic area. This can include non-autonomous vehicles that are online and/or offline with the service entity. For example, the operations computing system can communicate data indicative of a re-positioning assignment to a user device associated with a non-autonomous vehicle. The re-positioning assignment can request that the user re-position the non-autonomous vehicle to the geographic area. The re-positioning assignment can include an incentive (e.g., a financial incentive, etc.) to entice the operator of the non-autonomous vehicle to accept the re-positioning assignment. In some implementations, the re-positioning assignment can request that the non-autonomous vehicle be re-positioned away from the geographic area (e.g., to reduce vehicle supply in the event of a surplus).

In some implementations, the operations computing system can de-activate one or more autonomous vehicles. For instance, the operations computing system can obtain data indicating that the autonomous vehicles associated with a particular vehicle provider are required to undergo maintenance. The operations computing system can determine that these autonomous vehicles are to go offline with the service entity based at least in part on such information. The operations computing system can communicate data (e.g., to the autonomous vehicles, to a vehicle provider computing system, etc.) indicating that the autonomous vehicles are to go offline. In response, the autonomous vehicles can complete any current vehicle service assignments, go offline with the service entity (e.g., so that the autonomous vehicle can no longer obtain vehicle service assignments), and travel to a service depot, a based location, perform a pull-over maneuver, etc.

The systems and methods described herein provide a number of technical effects and benefits. More particularly, the systems and methods of the present disclosure provide improved techniques for decreasing idle data usage and autonomous vehicle downtime. To do so, aspects of the present disclosure allow a computing system to re-position autonomous vehicle(s) to certain geographic areas (e.g., imbalanced areas, etc.) while the autonomous vehicle(s) are offline so that the autonomous vehicles are more likely to obtain vehicle service assignments when they go online. This can increase the utilization rate of the autonomous vehicles. Moreover, such re-positioning can help reduce the amount of idle time experienced by the autonomous vehicle when the autonomous vehicle initially goes online with the service entity (e.g., by being re-positioned to a geographic area with a high demand for vehicle services). Additionally, this can decrease the amount of processing, memory, power, and other resources that the autonomous vehicle uses to perceive its surrounding environment while it is idle. Ultimately, this can lead to less vehicle downtime caused by trips to a service depot to downlink data, re-charge the vehicle's power sources, etc. This can also improve user wait time, increase vehicle compensation, increase the ability of the autonomous vehicles to meet service goals, etc.

Example aspects of the present disclosure can provide an improvement to vehicle computing technology, such as autonomous vehicle computing technology. For instance, the systems and methods of the present disclosure provide an improved approach to preserving the computational resources of an autonomous vehicle. For example, a computing system (e.g., an operations computing system of a service entity) can obtain data associated with an autonomous vehicle that is offline with a service entity. The computing system can obtain data indicative of a geographic area associated with the service entity (e.g., an imbalanced geographic area). The computing system can determine that the autonomous vehicle is to go online with the service entity within the first geographic area (and a time for doing so) based at least in part on the data associated with the autonomous vehicle and the data indicative of the geographic area. The computing system can communicate data indicative of an activation assignment associated with the autonomous vehicle. The activation assignment can be indicative of the geographic area within which the autonomous vehicle is to go online with the service entity and/or the time at which the autonomous vehicle is to go online. In this way, the computing system can decrease autonomous vehicle idle time and the amount of computational resources that an autonomous vehicle uses while it is idle. Moreover, the computing system can strategically determine which autonomous vehicle(s) to re-position so that the re-positioning is performed in the most efficient manner while the autonomous vehicle(s) are offline. Accordingly, the computing system can re-position the autonomous vehicle(s) so that the processing, memory, and power resources of the vehicle's computing system are more likely to be utilized for performing vehicle services (as opposed to vehicle idling), when the autonomous vehicle is activated on a service entity's network. This leads to a more effective use of an autonomous vehicle's computational resource, while reducing the need for an autonomous vehicle to go offline again to replenish such resources.

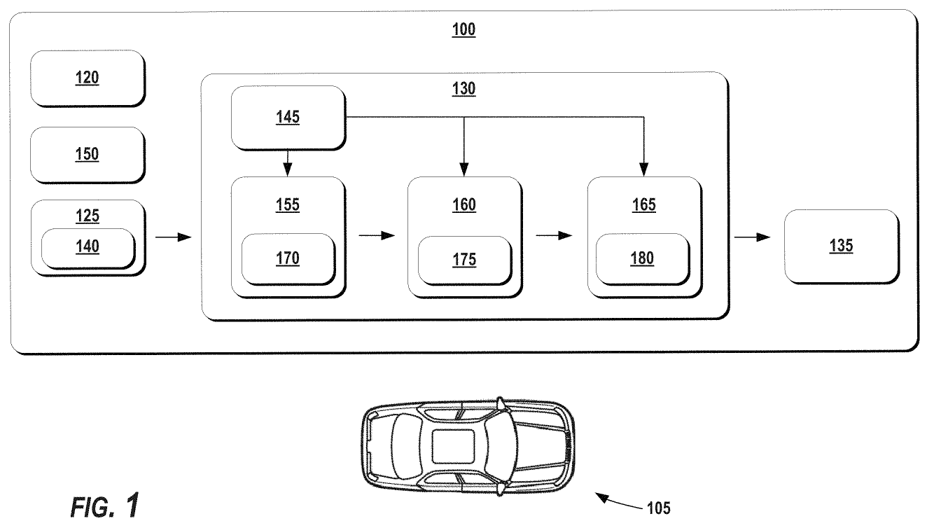

With reference now to the FIGS., example embodiments of the present disclosure will be discussed in further detail. FIG. 1 illustrates an example vehicle computing system 100 according to example embodiments of the present disclosure. The vehicle computing system 100 can be associated with an autonomous vehicle 105. The vehicle computing system 100 can be located onboard (e.g., included on and/or within) the autonomous vehicle 105.

The autonomous vehicle 105 incorporating the vehicle computing system 100 can be various types of vehicles. For instance, the autonomous vehicle 105 can be a ground-based autonomous vehicle such as an autonomous car, autonomous truck, autonomous bus, etc. The autonomous vehicle 105 can be an air-based autonomous vehicle (e.g., airplane, helicopter, or other aircraft) or other types of vehicles (e.g., watercraft, etc.). The autonomous vehicle 105 can drive, navigate, operate, etc. with minimal and/or no interaction from a human operator (e.g., driver). In some implementations, a human operator can be omitted from the autonomous vehicle 105 (and/or also omitted from remote control of the autonomous vehicle 105). In some implementations, a human operator can be included in the autonomous vehicle 105.

In some implementations, the autonomous vehicle 105 can be configured to operate in a plurality of operating modes. The autonomous vehicle 105 can be configured to operate in a fully autonomous (e.g., self-driving) operating mode in which the autonomous vehicle 105 is controllable without user input (e.g., can drive and navigate with no input from a human operator present in the autonomous vehicle 105 and/or remote from the autonomous vehicle 105). The autonomous vehicle 105 can operate in a semi-autonomous operating mode in which the autonomous vehicle 105 can operate with some input from a human operator present in the autonomous vehicle 105 (and/or a human operator that is remote from the autonomous vehicle 105). The autonomous vehicle 105 can enter into a manual operating mode in which the autonomous vehicle 105 is fully controllable by a human operator (e.g., human driver, pilot, etc.) and can be prohibited and/or disabled (e.g., temporary, permanently, etc.) from performing autonomous navigation (e.g., autonomous driving). In some implementations, the autonomous vehicle 105 can implement vehicle operating assistance technology (e.g., collision mitigation system, power assist steering, etc.) while in the manual operating mode to help assist the human operator of the autonomous vehicle 105.

The operating modes of the autonomous vehicle 105 can be stored in a memory onboard the autonomous vehicle 105. For example, the operating modes can be defined by an operating mode data structure (e.g., rule, list, table, etc.) that indicates one or more operating parameters for the autonomous vehicle 105, while in the particular operating mode. For example, an operating mode data structure can indicate that the autonomous vehicle 105 is to autonomously plan its motion when in the fully autonomous operating mode. The vehicle computing system 100 can access the memory when implementing an operating mode.

The operating mode of the autonomous vehicle 105 can be adjusted in a variety of manners. For example, the operating mode of the autonomous vehicle 105 can be selected remotely, off-board the autonomous vehicle 105. For example, a remote computing system (e.g., of a vehicle provider and/or service entity associated with the autonomous vehicle 105) can communicate data to the autonomous vehicle 105 instructing the autonomous vehicle 105 to enter into, exit from, maintain, etc. an operating mode. By way of example, such data can instruct the autonomous vehicle 105 to enter into the fully autonomous operating mode. In some implementations, the operating mode of the autonomous vehicle 105 can be set onboard and/or near the autonomous vehicle 105. For example, the vehicle computing system 100 can automatically determine when and where the autonomous vehicle 105 is to enter, change, maintain, etc. a particular operating mode (e.g., without user input). Additionally, or alternatively, the operating mode of the autonomous vehicle 105 can be manually selected via one or more interfaces located onboard the autonomous vehicle 105 (e.g., key switch, button, etc.) and/or associated with a computing device proximate to the autonomous vehicle 105 (e.g., a tablet operated by authorized personnel located near the autonomous vehicle 105). In some implementations, the operating mode of the autonomous vehicle 105 can be adjusted by manipulating a series of interfaces in a particular order to cause the autonomous vehicle 105 to enter into a particular operating mode.

The vehicle computing system 100 can include one or more computing devices located onboard the autonomous vehicle 105. For example, the computing device(s) can be located on and/or within the autonomous vehicle 105. The computing device(s) can include various components for performing various operations and functions. For instance, the computing device(s) can include one or more processors and one or more tangible, non-transitory, computer readable media (e.g., memory devices, etc.). The one or more tangible, non-transitory, computer readable media can store instructions that when executed by the one or more processors cause the autonomous vehicle 105 (e.g., its computing system, one or more processors, etc.) to perform operations and functions, such as those described herein for controlling an autonomous vehicle, activating an autonomous vehicle, recognizing that an autonomous vehicle is to be re-positioned, identifying a geographic area, directing an autonomous vehicle to be re-positioned, etc.

The autonomous vehicle 105 can include a communications system 120 configured to allow the vehicle computing system 100 (and its computing device(s)) to communicate with other computing devices. The vehicle computing system 100 can use the communications system 120 to communicate with one or more computing device(s) that are remote from the autonomous vehicle 105 over one or more networks (e.g., via one or more wireless signal connections). In some implementations, the communications system 120 can allow communication among one or more of the system(s) on-board the autonomous vehicle 105. The communications system 120 can include any suitable components for interfacing with one or more network(s), including, for example, transmitters, receivers, ports, controllers, antennas, and/or other suitable components that can help facilitate communication.

As shown in FIG. 1, the autonomous vehicle 105 can include one or more vehicle sensors 125, an autonomy computing system 130, one or more vehicle control systems 135, and other systems, as described herein. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can send and/or receive data, messages, signals, etc. amongst one another via the communication channel.

The vehicle sensor(s) 125 can be configured to acquire sensor data 140. This can include sensor data associated with the surrounding environment of the autonomous vehicle 105. For instance, the sensor data 140 can acquire image and/or other data within a field of view of one or more of the vehicle sensor(s) 125. The vehicle sensor(s) 125 can include a Light Detection and Ranging (LIDAR) system, a Radio Detection and Ranging (RADAR) system, one or more cameras (e.g., visible spectrum cameras, infrared cameras, etc.), motion sensors, and/or other types of imaging capture devices and/or sensors. The sensor data 140 can include image data, radar data, LIDAR data, and/or other data acquired by the vehicle sensor(s) 125. The autonomous vehicle 105 can also include other sensors configured to acquire data associated with the autonomous vehicle 105. For example, the autonomous vehicle 105 can include inertial measurement unit(s), wheel odometry devices, and/or other sensors.

In some implementations, the sensor data 140 can be indicative of one or more objects within the surrounding environment of the autonomous vehicle 105. The object(s) can include, for example, vehicles, pedestrians, bicycles, and/or other objects. The object(s) can be located in front of, to the rear of, to the side of the autonomous vehicle 105, etc. The sensor data 140 can be indicative of locations associated with the object(s) within the surrounding environment of the autonomous vehicle 105 at one or more times. The vehicle sensor(s) 125 can provide the sensor data 140 to the autonomy computing system 130.

In addition to the sensor data 140, the autonomy computing system 130 can retrieve or otherwise obtain map data 145. The map data 145 can provide information about the surrounding environment of the autonomous vehicle 105. In some implementations, an autonomous vehicle 105 can obtain detailed map data that provides information regarding: the identity and location of different roadways, road segments, buildings, or other items or objects (e.g., lampposts, crosswalks, curbing, etc.); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); the location of obstructions (e.g., roadwork, accidents, etc.); data indicative of events (e.g., scheduled concerts, parades, etc.); and/or any other map data that provides information that assists the autonomous vehicle 105 in comprehending and perceiving its surrounding environment and its relationship thereto. In some implementations, the vehicle computing system 100 can determine a vehicle route for the autonomous vehicle 105 based at least in part on the map data 145.

The autonomous vehicle 105 can include a positioning system 150. The positioning system 150 can determine a current position of the autonomous vehicle 105. The positioning system 150 can be any device or circuitry for analyzing the position of the autonomous vehicle 105. For example, the positioning system 150 can determine position by using one or more of inertial sensors (e.g., inertial measurement unit(s), etc.), a satellite positioning system, based on IP address, by using triangulation and/or proximity to network access points or other network components (e.g., cellular towers, WiFi access points, etc.), and/or other suitable techniques. The position of the autonomous vehicle 105 can be used by various systems of the vehicle computing system 100 and/or provided to a remote computing system. For example, the map data 145 can provide the autonomous vehicle 105 relative positions of the elements of a surrounding environment of the autonomous vehicle 105. The autonomous vehicle 105 can identify its position within the surrounding environment (e.g., across six axes, etc.) based at least in part on the map data. For example, the vehicle computing system 100 can process the sensor data 140 (e.g., LIDAR data, camera data, etc.) to match it to a map of the surrounding environment to get an understanding of the vehicle's position within that environment.

The autonomy computing system 130 can include a perception system 155, a prediction system 160, a motion planning system 165, and/or other systems that cooperate to perceive the surrounding environment of the autonomous vehicle 105 and determine a motion plan for controlling the motion of the autonomous vehicle 105 accordingly. For example, the autonomy computing system 130 can obtain the sensor data 140 from the vehicle sensor(s) 125, process the sensor data 140 (and/or other data) to perceive its surrounding environment, predict the motion of objects within the surrounding environment, and generate an appropriate motion plan through such surrounding environment. The autonomy computing system 130 can communicate with the one or more vehicle control systems 135 to operate the autonomous vehicle 105 according to the motion plan.

The vehicle computing system 100 (e.g., the autonomy computing system 130) can identify one or more objects that are proximate to the autonomous vehicle 105 based at least in part on the sensor data 140 and/or the map data 145. For example, the vehicle computing system 100 (e.g., the perception system 155) can process the sensor data 140, the map data 145, etc. to obtain perception data 170. The vehicle computing system 100 can generate perception data 170 that is indicative of one or more states (e.g., current and/or past state(s)) of a plurality of objects that are within a surrounding environment of the autonomous vehicle 105. For example, the perception data 170 for each object can describe (e.g., for a given time, time period) an estimate of the object's: current and/or past location (also referred to as position); current and/or past speed/velocity; current and/or past acceleration; current and/or past heading; current and/or past orientation; size/footprint (e.g., as represented by a bounding shape); class (e.g., pedestrian class vs. vehicle class vs. bicycle class), the uncertainties associated therewith, and/or other state information. The perception system 155 can provide the perception data 170 to the prediction system 160 (and/or the motion planning system 165).

The prediction system 160 can be configured to predict a motion of the object(s) within the surrounding environment of the autonomous vehicle 105. For instance, the prediction system 160 can generate prediction data 175 associated with such object(s). The prediction data 175 can be indicative of one or more predicted future locations of each respective object. For example, the prediction system 160 can determine a predicted motion trajectory along which a respective object is predicted to travel over time. A predicted motion trajectory can be indicative of a path that the object is predicted to traverse and an associated timing with which the object is predicted to travel along the path. The predicted path can include and/or be made up of a plurality of way points. In some implementations, the prediction data 175 can be indicative of the speed and/or acceleration at which the respective object is predicted to travel along its associated predicted motion trajectory. The prediction system 160 can output the prediction data 175 (e.g., indicative of one or more of the predicted motion trajectories) to the motion planning system 165.

The vehicle computing system 100 (e.g., the motion planning system 165) can determine a motion plan 180 for the autonomous vehicle 105 based at least in part on the perception data 170, the prediction data 175, and/or other data. A motion plan 180 can include vehicle actions (e.g., planned vehicle trajectories, speed(s), acceleration(s), other actions, etc.) with respect to one or more of the objects within the surrounding environment of the autonomous vehicle 105 as well as the objects' predicted movements. For instance, the motion planning system 165 can implement an optimization algorithm, model, etc. that considers cost data associated with a vehicle action as well as other objective functions (e.g., cost functions based on speed limits, traffic lights, etc.), if any, to determine optimized variables that make up the motion plan 180. The motion planning system 165 can determine that the autonomous vehicle 105 can perform a certain action (e.g., pass an object, etc.) without increasing the potential risk to the autonomous vehicle 105 and/or violating any traffic laws (e.g., speed limits, lane boundaries, signage, etc.). For instance, the motion planning system 165 can evaluate one or more of the predicted motion trajectories of one or more objects during its cost data analysis as it determines an optimized vehicle trajectory through the surrounding environment. The motion planning system 165 can generate cost data associated with such trajectories. In some implementations, one or more of the predicted motion trajectories may not ultimately change the motion of the autonomous vehicle 105 (e.g., due to an overriding factor). In some implementations, the motion plan 180 may define the vehicle's motion such that the autonomous vehicle 105 avoids the object(s), reduces speed to give more leeway to one or more of the object(s), proceeds cautiously, performs a stopping action, etc.

The motion planning system 165 can be configured to continuously update the vehicle's motion plan 180 and a corresponding planned vehicle motion trajectory. For example, in some implementations, the motion planning system 165 can generate new motion plan(s) for the autonomous vehicle 105 (e.g., multiple times per second). Each new motion plan can describe a motion of the autonomous vehicle 105 over the next planning period (e.g., next several seconds). Moreover, a new motion plan may include a new planned vehicle motion trajectory. Thus, in some implementations, the motion planning system 165 can continuously operate to revise or otherwise generate a short-term motion plan based on the currently available data. Once the optimization planner has identified the optimal motion plan (or some other iterative break occurs), the optimal motion plan (and the planned motion trajectory) can be selected and executed by the autonomous vehicle 105.

The vehicle computing system 100 can cause the autonomous vehicle 105 to initiate a motion control in accordance with at least a portion of the motion plan 180. A motion control can be an operation, action, etc. that is associated with controlling the motion of the vehicle. For instance, the motion plan 180 can be provided to the vehicle control system(s) 135 of the autonomous vehicle 105. The vehicle control system(s) 135 can be associated with a vehicle controller (e.g., including a vehicle interface) that is configured to implement the motion plan 180. The vehicle controller can, for example, translate the motion plan into instructions for the appropriate vehicle control component (e.g., acceleration control, brake control, steering control, etc.). By way of example, the vehicle controller can translate a determined motion plan 180 into instructions to adjust the steering of the autonomous vehicle 105 “X” degrees, apply a certain magnitude of braking force, etc. The vehicle controller (e.g., the vehicle interface) can help facilitate the responsible vehicle control (e.g., braking control system, steering control system, acceleration control system, etc.) to execute the instructions and implement the motion plan 180 (e.g., by sending control signal(s), making the translated plan available, etc.). This can allow the autonomous vehicle 105 to autonomously travel within the vehicle's surrounding environment.

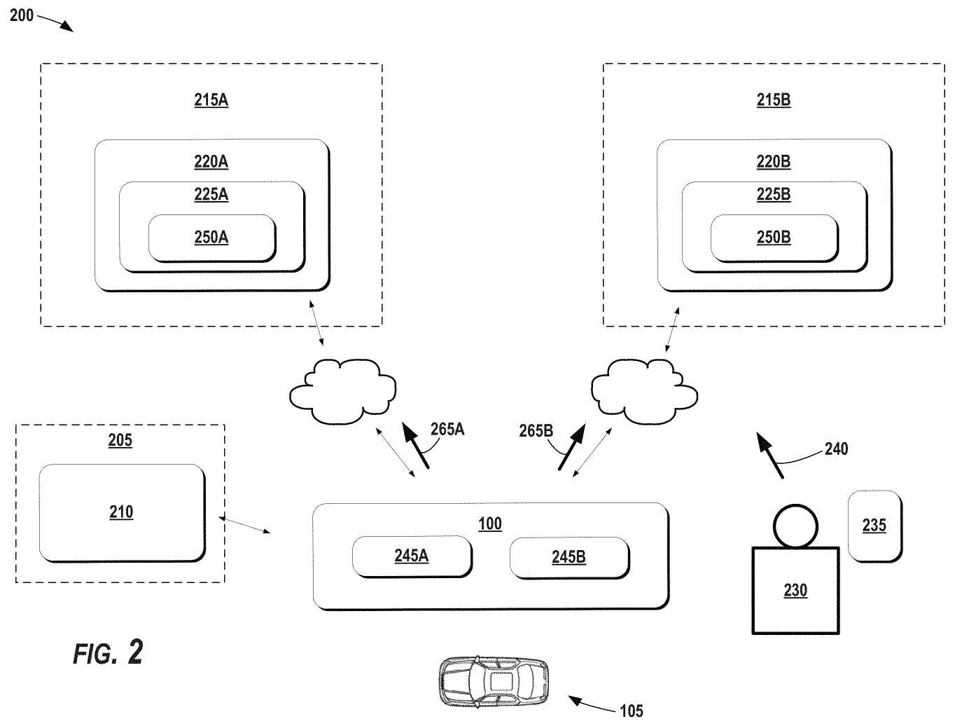

The autonomous vehicle 105 can be associated with a variety of different parties. For example, FIG. 2 depicts an example architecture 200 according to example embodiments of the present disclosure. As shown, the vehicle computing system 100 of the autonomous vehicle 105 can be configured to communicate with a plurality of different computing systems that are remote from the autonomous vehicle 105 via the architecture 200.

In some implementations, the autonomous vehicle 105 can be associated with a vehicle provider 205. The vehicle provider 205 can include, for example, an owner, a manufacturer, a vendor, a manager, a coordinator, a handler, etc. of the autonomous vehicle 105. The vehicle provider 205 can be an individual, a group of individuals, an entity (e.g., a company), a group of entities, a service entity, etc. In some implementations, the autonomous vehicle 105 can be included in a fleet of vehicles associated with the vehicle provider 205. The vehicle provider 205 can utilize a vehicle provider computing system 210 that is remote from the autonomous vehicle 105 to communicate (e.g., over one or more wireless communication channels) with the vehicle computing system 100 of the autonomous vehicle 105. The vehicle provider computing system 210 can include a server system (e.g., of an entity), a user device (e.g., of an individual owner), and/or other types of computing systems.

The autonomous vehicle 105 can be configured to perform vehicle services for a plurality of different service entities 215A-B. An autonomous vehicle 105 can perform a vehicle service by, for example and as further described herein, travelling (e.g., traveling autonomously) to a location associated with a requested vehicle service, allowing user(s) and/or item(s) to board or otherwise enter the autonomous vehicle 105, transporting the user(s) and/or item(s), allowing the user(s) and/or item(s) to deboard or otherwise exit the autonomous vehicle 105, etc. In this way, the autonomous vehicle 105 can provide the vehicle service(s) for a service entity to a user.

A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of one or more vehicle services to one or more users. For example, a service entity can offer vehicle service(s) to users via one or more software applications (e.g., that are downloaded onto a user computing device), via a website, and/or via other types of interfaces that allow a user to request a vehicle service. As described herein, the vehicle services can include transportation services (e.g., by which a vehicle transports user(s) from one location to another), delivery services (e.g., by which a vehicle transports/delivers item(s) to a requested destination location), courier services (e.g., by which a vehicle retrieves item(s) from a requested origin location and transports/delivers the item to a requested destination location), and/or other types of services.

Each service entity 215A-B can be associated with a respective telecommunications network system 220A-B of that service entity. A telecommunications network system can include the infrastructure to facilitate communication between the autonomous vehicle 105 and the various computing systems of the associated service entity that are remote from the autonomous vehicle 105. For example, a service entity 215A-B can utilize an operations computing system 225A-B of the service entity to communicate with, coordinate, manage, etc. autonomous vehicle(s) to perform the vehicle services of the service entity 215A-B. The telecommunications network system 220A-B can allow an autonomous vehicle 105 to utilize the back-end functionality of the operations computing system 225A-B (e.g., vehicle service assignment allocation, vehicle technical support, etc.).

An operations computing system 225A-B can include one or more computing devices that are remote from the autonomous vehicle 105 (e.g., located off-board the autonomous vehicle 105). For example, such computing device(s) can be components of a cloud-based server system and/or other type of computing system that can communicate with the vehicle computing system 100 of the autonomous vehicle 105, another computing system (e.g., a vehicle provider computing system 210, etc.), a user device, etc. The operations computing system 225A-B can be distributed across one or more location(s) and include one or more sub-systems. The computing device(s) of an operations computing system 225A-B can include various components for performing various operations and functions. For instance, the computing device(s) can include one or more processor(s) and one or more tangible, non-transitory, computer readable media (e.g., memory devices, etc.). The one or more tangible, non-transitory, computer readable media can store instructions that when executed by the one or more processor(s) cause the operations computing system 225A-B (e.g., the one or more processors, etc.) to perform operations and functions, such as communicating data to and/or obtaining data from vehicle(s), obtaining data associated with geographic area(s), identifying vehicle imbalances, re-positioning vehicles, coordinating the provision of vehicle services by vehicle(s), etc. as further described herein.

An operations computing system 225A can communicate with an autonomous vehicle 105 via the service entity's computing platform. A computing platform of a service entity 215A-B can provide the vehicle computing system 100 and the operations computing system 225A-B with a computing environment that allows the systems to communicate. A computing platform can include a variety of computer architectures. Moreover, the computing platform can include the software, hardware, application programming interface(s), etc. that are associated with the service entity 215A-B. Each service entity 215A-B may have a different computing platform that can allow the service entity's operations computing system 225A-B and the vehicle computing system 100 to communicate via the telecommunications network system 220A-B associated with the service entity. In some implementations, one or more service entities may utilize the same computing platform.

One or more of the components of a computing platform can be accessible by the vehicle computing system 100. For instance, to help communicate with the various different service entities 215A-B, a vehicle computing system 100 of the autonomous vehicle 105 can include a plurality of vehicle clients 245A-B, each associated with a different service entity 215A-B. For example, the autonomous vehicle 105 can include a first vehicle client 245A associated with a first service entity 215A and a second vehicle client 245B associated with a second service entity 215B (e.g., that is different than the first service entity 215A). A vehicle client can be a software platform component of the service entity's computing platform, that is stored onboard an autonomous vehicle 105. For example, a vehicle client can include firmware, software (e.g., a software application), etc. that is stored onboard the autonomous vehicle 105 (and/or in an offboard memory that is accessible by the autonomous vehicle 105) and that can allow the vehicle computing system 100 to communicate data to and/or obtain data from the operations computing system 225A-B associated with a service entity 215A-B. For example, a vehicle client 245A-B can allow the vehicle computing system 100 to receive data indicative of one or more vehicle service assignments from an associated service entity 215A-B. The vehicle client 245A-B can be provided to an autonomous vehicle 105 by an operations computing system 225A-B associated with a service entity 215A-B, provided to a vehicle provider computing system 210 that can then help implement the vehicle client 245A-B on the autonomous vehicle 105 (e.g., by communicating a configuration to the vehicle computing system 100), and/or other approaches. In some implementations, the operations computing system 225A-B and the vehicle computing system 100 can indirectly communicate. For example, the vehicle provider computing system 210 can serve as an intermediary between the operations computing system 225A-B and the vehicle computing system 100 such that at least some data is communicated from the operations computing system 225A-B (or the vehicle computing system 100) to the vehicle provider computing system 210 and then to the vehicle computing system 100 (or the operations computing system 225A-B).

A vehicle client 245A-B can be implemented via hardware and/or software onboard the autonomous vehicle 105. The vehicle computing system 100 can utilize the vehicle client 245A-B to access an application programming interface 250A-B associated with a service entity 215A-B. For example, the vehicle computing system 100 can invoke, via a vehicle client 245A-B, the application programming interface 250A-B to access a library indicative of a plurality of parameters. The library can include, for example, a central repository for parameters that can be used to generate a communication (e.g., query string, message, data set, etc.) to be sent to the service entity's operations computing system. In some implementations, each service entity 215A-B can be associated with a different application programming interface 250A-B. For example, a first service entity 215A can be associated with a first application programming interface 250A and a second service entity 215B can be associated with a second application programming interface 250B (e.g., which is different from the first application programming interface 250A). Additionally, or alternatively, one or more service entities can utilize the same application programming interface and/or the first and second application programming interfaces 250A-B can be the same (or at least similar).

A user 230 can request a vehicle service from a service entity 215A-B. For example, the user 230 can provide user input to a user device 235 to request a vehicle service (e.g., via a user interface associated with a mobile software application of the service entity, etc.). The user device 235 can communicate (e.g., directly and/or indirectly via another computing system) data 240 indicative of a request for a vehicle service to an operations computing system 225A-B associated with the service entity 215A-B. The request can indicate the type of vehicle service that the user 230 desires (e.g., a transportation service, a delivery service, a courier service, etc.), one or more locations (e.g., an origin location, a destination location, etc.), timing constraints (e.g., pick-up time, drop-off time, deadlines, etc.), a number of user(s) and/or items to be transported in the vehicle, one or more other service parameters (e.g., a need for handicap access, a need for trunk space, etc.), and/or other information. The operations computing system 225A-B of the service entity 215A-B can process the data 240 indicative of the request and generate a vehicle service assignment that is associated with the service request.

The operations computing system 225A-B of the service entity 215A-B can process the request and identify one or more autonomous vehicles that may be able to perform the requested vehicle services for the user 230. For instance, the operations computing system 225A-B can identify which vehicle(s) are online with the service entity.

An autonomous vehicle can be online with a service entity so that the autonomous vehicle is available to obtain data indicative of a vehicle service assignment associated with the service entity, so that the autonomous vehicle is available to address a vehicle service assignment, so that the autonomous vehicle is available to perform a vehicle service for the service entity, etc. For example, an autonomous vehicle 105 can go online with a service entity. An autonomous vehicle that is online with a service entity can be, for example, a vehicle that has performed one or more of: launching a vehicle client associated with the service entity, accessing an API associated with the service entity, establishing a communication session with a computing system of the service entity, connecting to a computing platform and/or a telecommunications network of the service entity, and/or taken other actions to go online with the service entity. The online vehicle can be able to communicate with the serve entity's computing system, for example, to obtain data (e.g., data indicative of vehicle service assignments).

The vehicle computing system 100 can go online with the computing platform and/or a first telecommunications network 220A of a first service entity 215A such that the autonomous vehicle 105 can communicate with the operations computing system 225A of the first service entity 215A. This can allow the vehicle computing system 100 to obtain data indicative of one or more vehicle service assignments associated with the first service entity 215A. By way of example, as described herein, the vehicle computing system 100 can include a first vehicle client 245A associated with the first service entity 215A. The vehicle computing system 100 can indicate the vehicle's availability to perform vehicle services and/or obtain vehicle service assignments from the first service entity. This can include launching the first vehicle client 245A. The vehicle computing system 100 can establish a first communication session with a first remote computing system associated with the first service entity 215A (e.g., the operations computing system 225A). The communication session can be opened based at least in part on a first application programming interface 250A associated with the first service entity 215A. For instance, the vehicle computing system 100 can access, via the first vehicle client 245A, the first application programming interface 250A associated with the first service entity 215A. The vehicle computing system 100 can generate a first communication 265A (e.g., data string, etc.) based at least in part on the first application programming interface 250A (e.g., based on the defined parameters thereof, etc.). The first communication 265A can indicate that the autonomous vehicle 105 is online with the first service entity 215A. The first communication 265A can indicate that the autonomous vehicle 105 is available to perform at least one first vehicle service for the first service entity 215A and/or is available to obtain vehicle service assignment(s) associated with the first service entity 215A (e.g., a computing system associated therewith). The vehicle computing system 100 can provide the first communication 265A to the operations computing system 225A of the first service entity 215A to indicate that the autonomous vehicle 105 is online with the first service entity 215A and that the autonomous vehicle 105 is available to perform vehicle service(s) for the first service entity 215A. Additionally, or alternatively, the vehicle computing system 100 can provide the first communication 265A to the vehicle provider computing system 210, which can provide the first communication 265A (or similar such data) to the operations computing system 225A to indicate that the autonomous vehicle 105 is online with the service entity and that the autonomous vehicle 105 is available to perform vehicle service(s) for the first service entity 215A. In some implementations, the vehicle provider computing system 210 can perform similar operations to communicate with the operations computing system of a service entity via an application programming interface.

A similar such approach can be utilized by the vehicle computing system 100 to go online with a second service entity 215B. For example, the vehicle computing system 100 can access, via the second vehicle client 245B, the second application programming interface 250B associated with the second service entity 215B. The vehicle computing system 100 can generate a second communication 265B based at least in part on the second application programming interface 250B. The second communication 265B can indicate that the autonomous vehicle 105 is online with the second service entity 215B. The second communication 265B can indicate that the autonomous vehicle 105 is available to perform at least one second vehicle service for the second service entity 215B and/or is available to obtain vehicle service assignment(s) associated with the second service entity 215B (e.g., a computing system associated therewith).

An autonomous vehicle can be offline with a service entity. For example, the autonomous vehicle 105 can be offline with the first service entity 215A such that the autonomous vehicle 105 is unavailable to perform the vehicle service(s) of the first service entity 215A (e.g., unavailable to obtain/accept vehicle service assignment(s)). While offline, however, the autonomous vehicle 105 may still be capable of obtaining information from the service entity 215A. For instance, the autonomous vehicle 105 (and/or an associated vehicle provider 205) can include a message data store (e.g., an inbox, message queue, etc.) that stores messages associated with the autonomous vehicle 105 while it is offline. This message data store can be accessible by the autonomous vehicle 105 (and/or an associated vehicle provider 205). The operations computing system of a service entity can communicate data messages for an autonomous vehicle 105 and such messages can be stored in the data store for the autonomous vehicle 105 (and/or an associated vehicle provider 205). The autonomous vehicle 105 (and/or an associated vehicle provider 205) can access the data store to obtain data indicative of a message such as, for example, an activation assignment from a service entity, as further described herein.

Example embodiments of the present disclosure describe operations and functions performed by an operations computing system, a vehicle provider computing system, and/or a vehicle computing system for illustrative purposes. One or more of the operations and functions described as being performed by one system can be performed by another. For example, the operations and functions of an operations computing system of a service entity can be performed by another computing system (e.g., the vehicle provider computing system 210, the vehicle computing system 100, etc.), and vice versa, and/or any combination thereof

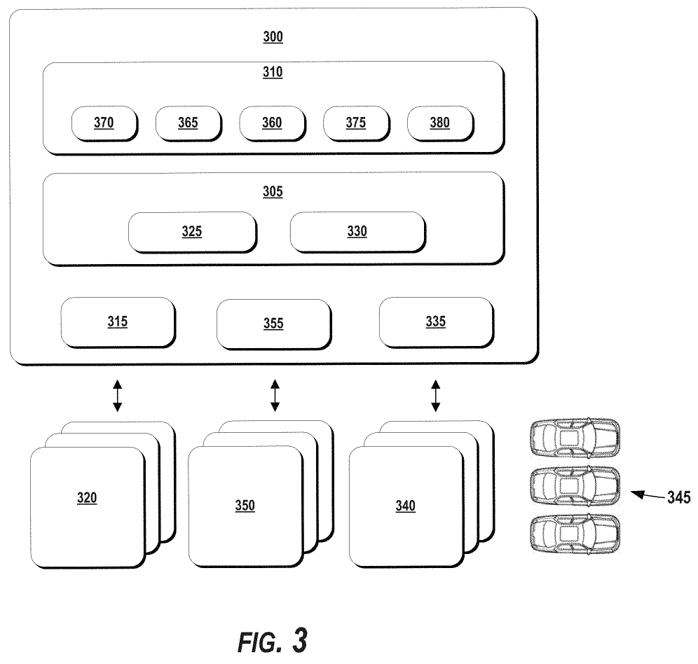

An operations computing system can be configured to position one or more vehicles (e.g., that are offline with an associated service entity) to reduce vehicle downtime and idle data usage when the vehicles go online with the service entity. FIG. 3 depicts an example operations computing system 300 of a service entity according to example embodiments of the present disclosure. The operations computing system 300 can be associated with a service entity (e.g., service entities 215A-B). The operations computing systems 225A-B of FIG. 2 associated with the respective service entities 215A-B, and/or otherwise described herein, can be or can be configured in a similar manner to the operations computing system 300. The operations computing system 300 can include a vehicle service coordination system 305, a vehicle re-positioning system 310, and/or other systems.

The vehicle service coordination system 305 can be configured to coordinate the provision of one or more vehicle services to one or more users. For instance, the operations computing system 300 can include a request interface 315. The request interface 315 can allow the operations computing system 300 to communicate with one or a plurality of user devices 320 (e.g., mobile phones, desktops, laptops, tablets, game systems, etc.). The user device(s) 320 can be and/or can include the user device 235 of FIG. 2. The request interface 315 can allow the operations computing system 300 and the user device(s) 320 to communicate data to and/or from one another. For example, the user device(s) 320 can communicate (e.g., via the request interface 315) data indicative of a service request 325 for a vehicle service to an operations computing system 300 associated with a service entity.

The vehicle service coordination system 305 can be configured to generate a vehicle service assignment 330. A vehicle service assignment 330 can be indicative of a vehicle service (e.g., requested by a user via the user device(s) 320) to be performed by a vehicle (e.g., an autonomous vehicle). A vehicle service assignment 330 can include a variety of information associated with the vehicle service, the requesting user, the user device, the service entity, etc. For example, a vehicle service assignment 330 can include data indicative of an associated user and/or user device (if permitted), data indicative of a compensation parameter (e.g., the compensation for delivering an item to a user, couriering an item for a user, transporting a user, etc.), data indicative of one or more locations (e.g., origin location, destination location, intermediate location, etc.), data indicative of a type of vehicle service (e.g., transportation service, delivery service, courier service, etc.), data indicative of the type of cargo for the vehicle service (e.g., passengers, luggage, packages, food, time-sensitive mail, etc.), data indicative of a vehicle type/size (e.g., sedan, sport utility vehicle, luxury vehicle, etc.), data indicative of one or more time constraints (e.g., pick-up times, drop-off times, time limits for delivery, service duration, etc.), data indicative of user preferences (e.g., music, temperature, etc.), data indicative of one or more vehicle service parameters (e.g., luggage types, handle-with-care instructions, special pick-up requests, etc.), data indicative of the vehicle capacity required/preferred for the vehicle service (e.g., the number of seats with seatbelts, an amount of trunk space, etc.), data indicative of user ratings, data indicative of one or more vehicle service incentives (as further described herein), and/or other types of data.

The operations computing system 300 (e.g., the vehicle service coordination system 305) can identity one or more autonomous vehicles that are available for a vehicle service assignment 330. The vehicle service coordination system 305 can identify autonomous vehicle(s) that are online with the service entity associated with the operations computing system 300. The vehicle service coordination system 305 can select an autonomous vehicle for the vehicle service assignment based at least in part on the data indicated in the vehicle service assignment. For example, the vehicle service coordination system 305 can select an autonomous vehicle that meets the preferences of the user, has the necessary capacity, is the requested vehicle type, etc. Additionally, or alternatively, the vehicle service coordination system 305 can select an autonomous vehicle based at least in part on the current and/or future location of the autonomous vehicle. For example, the vehicle service coordination system 305 can select an autonomous vehicle that is proximate to an origin location associated with the vehicle service assignment 330. Additionally, or alternatively, the vehicle service coordination system 305 can select an autonomous vehicle that is within and/or nearby a geographic area that includes the origin location and/or destination location of the vehicle service assignment 330.

The operations computing system 300 can utilize a vehicle interface 335 to communicate data indicative of a vehicle service assignment 330 to one or more vehicle computing systems 340 of one or more autonomous vehicles 345. The vehicle computing system(s) 340 can include the vehicle computing system 100 and/or be configured in similar manner (e.g., as shown in FIG. 1) and the autonomous vehicle(s) 345 can include the autonomous vehicle 105. The vehicle interface 335 can allow the operations computing system 300 and one or a plurality of vehicle computing systems 340 (e.g., of one or more autonomous vehicles 345) to communicate data to and/or from one another. For example, the operations computing system 300 can communicate, via the vehicle interface 335, data indicative of a vehicle service assignment 330 to one or more vehicle computing system(s) 340 of the autonomous vehicles 345 that the operations computing system 300 selects for the vehicle service assignment 330. Additionally, or alternatively, the vehicle computing system(s) 340 can communicate data associated with the autonomous vehicle(s) 345 to the operations computing system 300. In this way, the operations computing system 300 can coordinate the performance of vehicle service(s) for user(s) by the autonomous vehicle(s) 345 as well as monitor the autonomous vehicle(s) 345.

In some implementations, the operations computing system 300 can select a non-autonomous vehicle (e.g., human driven vehicle) for a vehicle service assignment 330. For example, the vehicle service coordination system 305 can select a non-autonomous vehicle that is proximate to a location associated with the vehicle service assignment 330. Additionally, or alternatively, the vehicle service coordination system 305 can select a non-autonomous vehicle that is within and/or nearby a geographic area that includes the origin location and/or destination location of the vehicle service assignment 330. The operations computing system 300 can utilize a vehicle interface 335 to communicate data indicative of a vehicle service assignment 330 to one or more computing devices associated with the selected non-autonomous vehicle (e.g., a mobile device of the vehicle operator). The vehicle service assignment 330 can be indicative of a request that the operator provide the requested vehicle service to a user associated with the vehicle service assignment 330.

The operations computing system 300 can communicate with one or more vehicle provider computing systems 350 (associated with one or more vehicle providers) via a vehicle provider interface 355. The vehicle provider computing system(s) 350 can include and/or be configured in a similar manner to the vehicle provider computing system 210 (shown in FIG. 2). The vehicle provider computing system(s) 350 can be associated with vehicle providers that are associated with the autonomous vehicle(s) 345. The vehicle provider interface 355 can allow the operations computing system 300 and one or a plurality of vehicle provider computing systems 350 (e.g., of one or more vehicle providers, etc.) to communicate data to and/or from one another. For example, the operations computing system 300 can communicate, via the vehicle provider interface 355, data indicative of a vehicle service assignment 330, and/or other data as described herein, to one or more vehicle provider computing system(s) 350. The vehicle provider computing system(s) 350 can then communicate such data to the vehicle computing system(s) 340. Additionally, or alternatively, the vehicle provider computing system(s) 350 can communicate data associated with one or more autonomous vehicles 345 (and/or other data) to the operations computing system 300.

A service entity may have varying levels of control over the vehicle(s) that perform its vehicle services. In some implementations, a vehicle can be included in the service entity's dedicated supply of vehicles. The dedicated supply can include vehicles that are owned, leased, or otherwise exclusively available to the service entity (e.g., for the provision of its vehicle service(s), other tasks, etc.) for at least some period of time. This can include, for example, an autonomous vehicle 345 that is associated with a vehicle provider, but that is online only with that service entity (e.g., available to accept vehicle service assignments for only that service entity, etc.) for a certain time period (e.g., a few hours, a day, week, etc.).

In some implementations, a vehicle can be included in the service entity's non-dedicated supply of vehicles. This can include vehicles that are not exclusively available to the service entity. For example, an autonomous vehicle 345 that is currently online with two different service entities (e.g., concurrently online with a first service entity 215A and a second service entity 215B, etc.) so that the autonomous vehicle 345 may accept vehicle service assignment(s) 330 from either service entity (e.g., the operations computing systems associated therewith, etc.) may be considered to be part of a non-dedicated supply of autonomous vehicles. In some implementations, whether a vehicle is considered to be part of the dedicated supply or the non-dedicated supply can be based, for example, on an agreement between the service entity and a vehicle provider associated with the autonomous vehicle 345.

A service entity can seek to decrease the amount of time that an autonomous vehicle 345 may be idle when the autonomous vehicle 345 initially goes online with the service entity. For example, the operations computing system 300 can aim to decrease the amount of time that the autonomous vehicle 345 is in an idle state when it goes online with a service entity. An idle state can be a state in which the autonomous vehicle is not addressing a vehicle service assignment and/or performing a vehicle service. This can include the time between vehicle service assignments. To help decrease the potential idle time, the operations computing system 300 can obtain data 360 associated with one or a plurality of autonomous vehicles that are offline with a service entity (e.g., the first service entity 215A). These can be autonomous vehicle(s) that are a part of the service entity's dedicated supply or non-dedicated supply. Moreover, these can be autonomous vehicle(s) that are included in the vehicle fleet of a vehicle provider. The data associated with these offline autonomous vehicle(s) can be indicative of at least one of: data indicative of a preference of one or more vehicle services that the autonomous vehicle is configured to perform (e.g., transportation services, delivery services, etc.), data indicative of whether the autonomous vehicle is included in a dedicated or non-dedicated supply of the service entity, data indicative of one or more geographic constraints for the autonomous vehicle (e.g., restrictions on where an autonomous vehicle can travel), data indicative of one or more vehicle characteristics for the autonomous vehicle (e.g., make, model, type, shape, size, etc.), data indicative of a performance rating for the autonomous vehicle (and/or the rating of an associated vehicle provider), data indicative of a location of the autonomous vehicle (e.g., an autonomous vehicle's current and/or future planned location, where the autonomous vehicle is parked while offline, where autonomous vehicle is scheduled to be when it goes online, etc.), or data indicative of a configured preference to perform vehicle service pooling by the autonomous vehicle. In some implementations, the data 360 can be indicative of the vehicle provider associated with an autonomous vehicle and/or other information (e.g., past usage, maintenance schedules, etc.). In some implementations, the data 360 can be indicative of one or more preferred destinations of the autonomous vehicle 345 (e.g., where the vehicle would like to be located when it goes online, etc.). In some implementations, the data 360 can be indicative of a time (e.g., point in time, time period, etc.) at which the autonomous vehicle 345 plans to, is scheduled to, will, etc. go online. In some implementations, the data 360 can include data (e.g., communicated from an autonomous vehicle 345) that indicates a request that the associated vehicle be re-positioned while it is offline, as further described herein. The operations computing system can utilize the data 360 associated with the autonomous vehicle(s) 345 to identify which autonomous vehicles 345 are available for offline re-positioning, to help reduce the potential for an autonomous vehicle 345 to waste its resources when it goes online (e.g., while in an idle state).

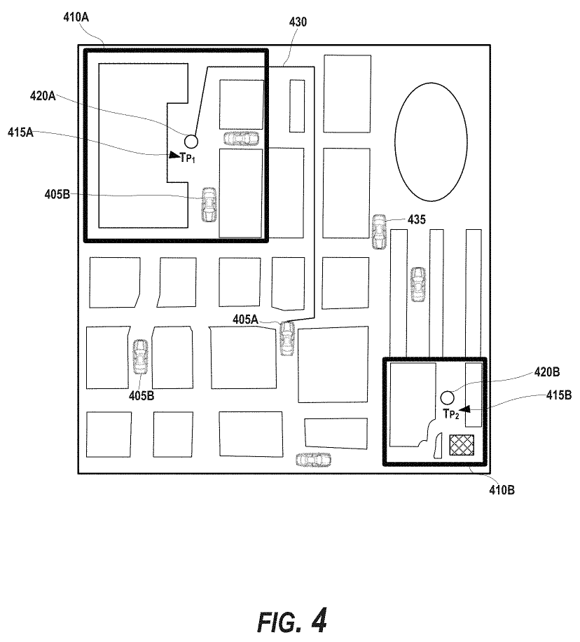

For example, with reference to FIG. 4, the operations computing system can obtain data 360 associated with an autonomous vehicle that is offline with a service entity such as, for example, a first autonomous vehicle 405A. The data 360 associated with the first autonomous vehicle 405A can indicate that the first autonomous vehicle 405A is online with the first service entity 215A; that the first autonomous vehicle 405A is configured to perform transportation services, delivery services, etc.; the current location of the first autonomous vehicle 405A (e.g., where it is parked, docked, charging, in sleep mode, etc.); whether the first autonomous vehicle 405A is a part of the dedicated supply of the first service entity 215A; any geographic constraints of the first autonomous vehicle 405A; the make, model, size, etc. of the autonomous vehicle 405A (e.g., the first autonomous vehicle is an SUV); the associated vehicle provider 205 of the first autonomous vehicle 405; the performance rating of the first autonomous vehicle 405A (and/or its vehicle provider 205); whether the first autonomous vehicle 405A is configured for service pooling (e.g., the pooling of transportation services); and/or other information associated with the first autonomous vehicle 405A. The operations computing system 300 can use this data to identify the first autonomous vehicle 405A as a candidate for offline re-positioning to help reduce potential idle time when the first autonomous vehicle 405A eventually goes online with the service entity.

Returning to FIG. 3, to help determine where an autonomous vehicle may be re-positioned, the operations computing system 300 can obtain data 365 associated with one or more geographic areas associated with the service entity. For example, these can be geographic areas in which the service entity offers vehicle service(s), geographic area(s) in which previous vehicle service assignments associated with the service entity have been completed, geographic area(s) in which future vehicle service requests are predicted, geographic area(s) in which the service entity plans to offer vehicle services, etc. The data 365 associated with a geographic area can be indicative of, for example, the past, present, and/or future (e.g., known and/or predicted) of at least one of: data indicative of a demand for one or more vehicle services associated with the geographic area (e.g., the number of service requests that begin, end, have an intermediate location within, and/or involve the traversal of the geographic area, etc.), data indicative of a number of vehicles associated with the geographic area (e.g., the number of non-autonomous vehicles, the number of autonomous vehicles, etc.), data indicative of a utilization rate for the vehicles associated with the geographic area, data indicative of an event associated with the geographic area (e.g., concerts, sporting events, performances, etc.), or data indicative of a weather condition associated with the geographic area (e.g., rain, snow, high/low temperatures, etc.).

In some implementations, the operations computing system 300 can utilize past and/or current data to project future parameters associated with a geographic area. For example, the operations computing system 300 can predict a future demand for vehicle services within a geographic area based at least in part on a past and/or current demand for vehicle services with like circumstances (e.g., similar time of day, season, occurrence, weather, etc.).

In some implementations, the data 365 can be indicative of other information. For example, the data 365 associated with the geographic area(s) can also be indicative of whether autonomous vehicles are permitted and/or capable of operating within the area. In some implementations, the data 365 associated with the geographic area(s) can be indicative of one or more conditions imposed on non-autonomous vehicles (e.g., service conditions imposed by the service entity within an area, etc.). This can include, for example, constraints on the types of vehicle services that non-autonomous vehicles can provide and/or constraints on the geographic boundaries within which the non-autonomous vehicles can travel. In some implementations, the data 365 associated with the geographic area(s) can include time specific information associated with a geographic area. The time specific information can indicate, for example, times at which it may be difficult for an autonomous vehicle to operate within the geographic area (e.g., power blackouts typically occur between 12 AM to 5 AM, etc.).

The operations computing system 300 can identify which geographic area(s) have a vehicle imbalance based at least in part on the data 365 associated with the geographic area(s). This can include a present and/or future imbalance in the number of vehicles associated with the geographic area. The vehicles associated with a geographic area can be vehicles that are available to perform vehicle service(s) that begin, traverse, and/or end within the geographic area. This can include non-autonomous vehicles and/or autonomous vehicles. The vehicle imbalance can include, for example, a surplus or a deficit in the number of vehicles (e.g., non-autonomous vehicles and/or autonomous vehicles) available to perform one or more vehicle services as compared to a demand for the one or more vehicles services. (e.g., autonomous vehicles that are located within the geographic area and/or are available to perform vehicle service(s) of the service entity that begin, traverse, and/or end within the geographic area, etc.).

The operations computing system 300 can determine that a geographic area has an imbalance in the number of vehicles associated with the geographic area based at least in part on the data 365 associated with the geographic area. By way of example, with reference to FIG. 4, the operations computing system 300 can obtain data 365 associated with a geographic area associated with the service entity such as, for example, a first geographic area 410A. The data 365 associated with the first geographic area 410A can indicate, for example, the number of vehicles (e.g., non-autonomous and/or autonomous vehicles) within the first geographic area 410 and data indicative of a demand for one or more vehicle services associated with the first geographic area 410A (e.g., a volume of service requests). This can include a current and/or future number of vehicles within the first geographic area 410A and a current and/or future number of service requests associated with the first geographic area 410A. The operations computing system 300 can determine that there should be an increase in the number of vehicles within the first geographic area 410A in the event that the current and/or future number of service requests (e.g., demand for vehicle service(s)) outweighs the current and/or future supply of vehicles within the geographic area (e.g., the first geographic area 410A experiences a deficit). As such, the first geographic area 410A represents an opportunity of where the supply of autonomous vehicles can be adjusted to increase the opportunity for an autonomous vehicle to receive vehicle service assignments.

Returning to FIG. 3, The operations computing system 300 can determine where an offline autonomous vehicle should be activated based at least in part on the data 360 associated with the autonomous vehicle(s) 345 and the data 365 associated with the geographic area(s). Such determination can be made based at least in part on heuristics and/or machine-learned models (e.g., trained to recommend geographic areas and/or autonomous vehicles, etc.). For example, the operations computing system 300 can store one or more rules-based algorithms that are designed to identify the optimal candidate vehicles to be re-positioned and/or the optimal candidate geographic areas based at least in part on the data 360 associated with autonomous vehicle(s) and the data 365 associated with the geographic area 400. These rules can identify, for example, autonomous vehicles 345 that are offline and closest to the first geographic area 410A as candidate vehicle(s) to be re-positioned with respect to the geographic area 410A.

Additionally, or alternatively, the determination as to which autonomous vehicles 345 to re-position can be made based at least in part on one or more machine-learned models. For example, the machine-learned models can include neural networks (e.g., deep neural networks), and/or other multi-layer non-linear models. Neural networks can include feed-forward neural networks (e.g., convolutional neural networks), recurrent neural networks (e.g., long short-term memory recurrent neural networks), and/or other forms of neural networks. The machine-learned model(s) can be trained to recommend autonomous vehicles for re-positioning to a geographic area and/or geographic areas to which autonomous vehicles should be re-positioned. For example, the machine-learned models can be trained based at least in part on a set of labelled training data that includes labels indicating which autonomous vehicles would be most appropriate for re-positioning with respect to a geographic area and/or which geographic areas are or will experience a vehicle imbalance. In some implementations, the training data can be based at least in part on real-world data associated with autonomous vehicle(s) and/or geographic area(s).

The operations computing system 300 can determine that an autonomous vehicle is to go online with the service entity within the geographic area based at least in part on the data 360 associated with the autonomous vehicle and the data 365 indicative of the geographic area. By way of example, with reference again to FIG. 4, the operations computing system 300 can determine that the first geographic area 410A is where the first autonomous vehicle 405A is to go online with the service entity. The first geographic area 410A can be a geographic area that is predicted to have a vehicle imbalance at a future time. For example, the first geographic area 410A can be an airport facility. The operations computing system 300 can predict that the airport facility will have a deficit in the number of non-autonomous vehicles (e.g., human-driven vehicles) and/or autonomous vehicles that are within the airport facility as compared to the demand for transportation services (e.g., rideshare trips transporting users away from the airport facility). The operations computing system 300 can determine that the first autonomous vehicle 405A should travel to the first geographic area 410A (e.g., the airport facility) and then be activated to go online with the service entity. This can allow the first autonomous vehicle 405A to go online within a geographic area in which it is more likely to obtain vehicle service assignments.

The operations computing system 300 can select the first autonomous vehicle 405A from among a plurality of autonomous vehicles for the first geographic area 410, as depicted in FIG. 4. For example, the operations computing system 300 can identify that the first autonomous vehicle 405A is offline with the service entity, is a part of the service entity's dedicated supply, is within proximity of the first geographic area 410A (e.g., the airport facility), is an appropriate type of vehicle (e.g., a sport utility vehicle), etc.

In some implementations, the operations computing system 300 can select a geographic area for an autonomous vehicle based on whether (or not) autonomous vehicles can operate in the area. For example, the first geographic area 410A (e.g., an airport facility) can be a geographic area that is familiar to and/or sufficiently mapped for the first autonomous vehicle 405A. The operation computing system 300 may not select a particular geographic area for the first autonomous vehicle 405A in the event that the particular area is unfamiliar, unmapped, and/or otherwise prohibitive to autonomous vehicle operation.

In some implementations, the operations computing system 300 can utilize a more global type of analysis when determining which autonomous vehicles should be re-positioned. For instance, the operations computing system 300 can utilize a cost analysis, machine-learned model, optimization heuristics, etc. to determine what effects the re-positioning of certain autonomous vehicles may have on each of the other autonomous vehicles that are offline and/or online with the service entity. The operations computing system 300 can determine how re-positioning some autonomous vehicles with respect to a geographic area may affect the number of vehicle service assignments given to another vehicle as well as the potential increase in idle time for another autonomous vehicle. The operations computing system 300 can perform a cost analysis to determine the least costly approach across all of the autonomous vehicles that are offline and/or online with the service entity (e.g., the re-positioning determination that leads to the lowest amount of vehicle idle time).

With reference to FIG. 3, the operations computing system 300 can determine when an autonomous vehicle 345 should go online with a service entity. As similarly described herein, such determination can be made based at least in part on heuristics and/or machine-learned models. For example, the operations computing system 300 can store one or more rules-based algorithms that are designed to identify the optimal times (e.g., points in time, time periods, etc.) at which an autonomous vehicle 345 should go online with a service entity (e.g., first service entity 215A). These rules can identify, for example, times at which a geographic area is predicted to experience a vehicle imbalance.

Additionally, or alternatively, the determination as to when an autonomous vehicle 345 should go online with a service entity can be made based at least in part on one or more machine-learned models. For example, the machine-learned models can include neural networks (e.g., deep neural networks), and/or other multi-layer non-linear models. Neural networks can include feed-forward neural networks (e.g., convolutional neural networks), recurrent neural networks (e.g., long short-term memory recurrent neural networks), and/or other forms of neural networks. The machine-learned model(s) can be trained to recommend one or more points in time and/or time periods at which an autonomous vehicle 345 should go online with a service entity. For example, the machine-learned models can be trained based at least in part on a set of training data that indicates the appropriate times for an autonomous vehicle 345 to be activated within a certain geographic area (e.g., when the geographic area is experience a vehicle deficit). In some implementations, the training data can be based at least in part on real-world data associated with the autonomous vehicle(s) and/or geographic area(s).

For instance, the operations computing system 300 can determine a time parameter 370 based at least in part on the data 360 associated with the autonomous vehicle(s) 345 and the data 365 associated with the geographic area(s). The time parameter 370 can be indicative of at least one of a point in time at which an autonomous vehicle 345 is to go online with the service entity or a time period during which an autonomous vehicle 345 is to go online with the service entity. The time parameter 370 can be a future point in time at which, or a future time period during which, an autonomous vehicle is to go online with the service entity. In various implementations, the time parameter 370 may be unbounded (e.g., open-ended, such as including only a starting time) or bounded (e.g., including a starting time and ending time).

The time parameter 370 can correspond to a time at which a geographic area is predicted to experience a vehicle imbalance. For instance, the operations computing system 300 can predict that a geographic area will have a vehicle imbalance during at least one of the point in time at which the autonomous vehicle 345 is to go online with the service entity or the time period during which the autonomous vehicle 345 is to go online with the service entity. In this way, the operations computing system 300 can cause an autonomous vehicle 345 to go online with a service entity in accordance with a time parameter 370 that reflects a time at which the autonomous vehicle 345 is more likely to obtain a vehicle service assignment (e.g., during a vehicle deficit).

By way of example, with reference to FIG. 4, the operations computing system 300 can determine a first time parameter 415A indicative of when the first autonomous vehicle 405A is to go online with the service entity (e.g., the first service entity 215A) based at least in part on the data 360 associated with the autonomous vehicle(s) and the data 365 associated with the geographic area(s). By way of example, the operations computing system 300 can predict that the first geographic area 410A (e.g., an airport facility) may experience a deficit in the number of vehicles available to provide transportation services from 8:00 AM to 10:30 AM on a Monday based on the historic demand for vehicle services and the projected supply of vehicles within the geographic area at that time. Accordingly, the operations computing system 300 can determine that the first autonomous vehicle 405A should be re-positioned to the first geographic area 415A and should go online within the first geographic area 410A during this time period.

In some implementations, a time parameter 370 can be based at least in part the activation and/or de-activation tendencies of other vehicles. For example, the operations computing system 300 may select a first time parameter 415A such that the first autonomous vehicle 405A goes online with the service entities during a time when other vehicles (e.g., non-autonomous and/or autonomous vehicles) are going offline with the service entity. In this way, the operations computing system 300 can aim to maintain a more consistent supply of vehicles to perform vehicle service(s).

In some implementations, a time parameter 370 can be determined based at least in part on weather conditions associated with the geographic area. For instance, the operations computing system 300 can select a first time parameter 415A, for the first autonomous vehicle 405A, that does not correspond to when the first geographic area 410A is expected to have weather conditions that may affect autonomous vehicle operation (e.g., heavy snowfall, rainfall, etc.). In the event that a vehicle deficit occurs within the first geographic area during such conditions, the operations computing system 300 may communicate with operators of non-autonomous vehicles to increase the supply of vehicles within the first geographic area 410A.

Additionally, and/or alternatively, the time parameter 370 can be determined based at least in part on other time specific information associated with the geographic data. For example, the operations computing system 300 can select a first time parameter 415A for the first autonomous vehicle 405A that is outside of a time period at which a geographic area typically experiences blackouts (e.g., which may hinder wireless communication with the first autonomous vehicle 405A). In some implementations, the time parameter 370 can be selected to correspond to when an event (e.g., concert, sporting event, etc.) may occur in the geographic area.

In some implementations, an autonomous vehicle and/or a vehicle provider can request that an autonomous vehicle be re-positioned while offline. For example, the first autonomous vehicle 405A itself and/or a computing system associated with a vehicle provider (e.g., a vehicle provider computing system 210) can determine that the first autonomous vehicle 405A will be coming online with the service entity (e.g., the first service entity 215A). The first autonomous vehicle 405A and/or an associated vehicle provider computing system can communicate data to the operations computing system 300, requesting that the first autonomous vehicle 405A be re-positioned while it is offline. In this way, an autonomous vehicle and/or vehicle provider computing system can request an offline re-positioning that would afford the autonomous vehicle a better opportunity to obtain vehicle service assignments when it goes online.

In some implementations, the operations computing system 300 may select at least a subset of a vehicle provider's fleet to be re-positioned with respect to the geographic area. For example, a plurality of autonomous vehicles can be associated with a vehicle provider. The plurality of autonomous vehicles can make-up and/or be included in a vehicle provider's fleet and can be offline with the service entity. In a manner as similarly described herein, the operations computing system 300 can determine that at least a subset of the plurality of autonomous vehicles are to go online with the service entity within a geographic area (e.g., the first geographic area 410A) based at least in part on the data 360 associated with the plurality of autonomous vehicles (e.g., within the vehicle provider's fleet) and the data 365 indicative of the geographic area. In some implementations, the operations computing system 300 may not determine which of those specific autonomous vehicles are to be re-positioned. Instead, the operations computing system 300 can allow the vehicle provider to determine which of the autonomous vehicles in its offline fleet are to be re-positioned. This can give the vehicle provider the flexibility to determine which vehicle(s) it prefers to re-locate.

With reference to FIG. 3, the operations computing system can generate one or more activation assignments 375 to help implement the offline re-positioning of autonomous vehicle(s) 345. The activation assignment(s) 375 can be indicative of at least a portion of the geographic area (e.g., within which an autonomous vehicle is to go online with a service entity). An activation assignment 375 can indicate that an autonomous vehicle 345 is to arrive at, get as close as possible to, get within a distance of (e.g., a threshold distance of, a reasonable walking distance of, etc.), circle nearby, etc. a location within the geographic area when the autonomous vehicle 345 activates to go online with the service entity. Additionally, or alternatively, the activation assignment(s) 375 can be indicative of a time parameter 370, which indicates when the autonomous vehicle 345 should go online with the service entity. As described herein, the time parameter 370 can include at least one of a point in time or a time period at which an autonomous vehicle 345 is to go online with a service entity.

The operations computing system 300 can communicate data indicative of an activation assignment 375 associated with an autonomous vehicle 345. By way of example, with reference to FIG. 4, the operations computing system 300 can communicate data indicative of a first activation assignment to the first autonomous vehicle 405A. The first activation assignment can indicate that the first autonomous vehicle 405A is to go online within the first geographic area 410A (e.g., the airport facility, etc.) within at a particular time and/or within a certain time period (e.g., between 7:45 am-8:15 am, etc.) as indicated by the time parameter 370. The first autonomous vehicle 405A may not be located within the geographic area (e.g., when it obtains the first activation assignment). The first activation assignment can indicate that the first autonomous vehicle 405A be re-positioned within the first geographic area 410A (e.g., autonomously travel to the geographic area, etc.) prior to going online with the service entity. For instance, the first activation assignment can be indicative of at least a portion of the first the geographic area 410A such as, for example, a first location 420A, to which the first autonomous vehicle 405A is to travel to, arrive within a certain distance of, etc. In some implementations, the first activation assignment can include a route 430 for first autonomous vehicle 405A to follow to the first geographic area 410A.

With reference to FIG. 3, the activation assignment(s) 375 can include a command or a request. For example, an activation assignment 375 can be formulated as a command for the autonomous vehicle(s) 345 that are included in the dedicated supply of the service entity. In some implementations, the command may not be rejected unless the autonomous vehicle 345 is physically impaired from complying. Accordingly, the operations computing system 300 can utilize such commands for the autonomous vehicle(s) 345 that are included in the dedicated supply of the service entity. In some implementations, an activation assignment 375 can be formulated as a request that may be accepted or rejected. For example, an activation assignment 375 can include a request for an autonomous vehicle 345 to re-position to a geographic area while the autonomous vehicle 345 is offline in the event that the autonomous vehicle 345 is included in the non-dedicated supply of the service entity (e.g., the vehicle(s) that have the ability to accept or reject the re-positioning assignment). In some implementations, an activation assignment 375 can include a vehicle service incentive to help entice an acceptance of the activation assignment 375. The vehicle service incentive can include, for example, an increase in the compensation for the autonomous vehicle's next vehicle service assignment(s), increased rating, priority treatment for vehicle service assignment(s), etc.

The activation assignment(s) 375 can be communicated directly or indirectly to the autonomous vehicle(s) 345. For example, the operations computing system 300 can communicate data indicative of an activation assignment 375 directly to a vehicle computing system 340 of an autonomous vehicle 345 (e.g., via one or more wireless networks, etc.). Additionally, or alternatively, data indicative of an activation assignment 375 can be communicated to a vehicle provider associated with the autonomous vehicle 345. For example, as described herein, the operations computing system 300 can determine that at least a subset of a vehicle provider's fleet are candidates for offline re-positioning and that it would be satisfactory if any of these autonomous vehicles are re-positioned with respect to a geographic area. The operations computing system 300 can communicate data indicative of one or more activation assignments 375 associated with at least the subset of the plurality of autonomous vehicles. For instance, the operations computing system 300 can communicate the data indicative of the one or more activation assignments 375 to a computing system associated with the vehicle provider (e.g., a vehicle provider computing system 350). For example, the one or more activation assignments 375 can be indicative of a request for the subset of autonomous vehicles to re-position within a geographic area prior to going online with the service entity within the geographic area. In some implementations, the one or more activation assignments 375 can be indicative of a vehicle service incentive associated with the re-positioning of the subset of autonomous vehicles to the geographic area. The vehicle provider (e.g., the vehicle provider computing system 350) can select one or more of its autonomous vehicles to be re-positioned and communicate with those autonomous vehicle(s) accordingly.

In some implementations, the operations computing system 300 can confirm that an autonomous vehicle 345 has undertaken an activation assignment 375. The operations computing system 300 can obtain data indicating that an autonomous vehicle 345 is online with the service entity and is located within the geographic area. Additionally, or alternatively, the operations computing system 300 can determine whether the autonomous vehicle is autonomously re-positioning itself with respect a geographic area. For example, the operations computing system 300 can obtain data indicative of a vehicle's motion plan to determine whether the autonomous vehicle intends to travel to the geographic area as instructed. Additionally, or alternatively, the operations computing system 300 can determine whether an autonomous vehicle has arrived at a geographic area based at least in part on location data (e.g., GPS data, etc.) associated with the autonomous vehicle. Additionally, or alternatively, an autonomous vehicle 345 and/or an associated vehicle provider computing system 350 can communicate data to the operations computing system 300 indicating that the activation assignment 375 has been accepted and/or that the autonomous vehicle 345 will undertake/is undertaking the activation assignment 375 (e.g., autonomously travelling to the requested geographic area). By way of example, the operations computing system 300 can obtain data (e.g., motioning planning data, location data, an acceptance communication, etc.) indicating that the first autonomous vehicle 405A is travelling to the first geographic area 410A in accordance with the first activation assignment. The operations computing system 300 can obtain data indicating that the first autonomous vehicle 405A is online with the service entity (e.g., data requesting a vehicle service assignment for the first autonomous vehicle, a notification that the first autonomous vehicle is online, etc.) and that the first autonomous vehicle 405A is located within the first geographic area 410A.

The operations computing system can communicate data indicative of a vehicle service assignment 330 for an autonomous vehicle 345. For instance, the operations computing system 300 can communicate data indicative of a vehicle service assignment 330 to an autonomous vehicle 345 that has been re-positioned to a geographic area, as instructed, and has gone online with the associated service entity. The vehicle service assignment can be indicative of a requested vehicle service to be performed at least in part within the geographic area. By way of example, with reference to FIG. 4, after confirming that the first autonomous vehicle 405A has gone online within the first geographic area 410A, the operations computing system 300 can communicate data indicative of a first vehicle service assignment associated with the first geographic area 410A to the first autonomous vehicle 405A (and/or a vehicle provider computing system 350 associated therewith). The first vehicle service assignment can include, for example, a request to transport a user from one location within the first geographic area 410A to another. In this way, the operations computing system 300 can make sure that the first autonomous vehicle 405A, which has been re-positioned while offline with the service entity, can obtain a vehicle service assignment while online with the service entity (e.g., reducing idle data usage).

In some implementations, the operations computing system 300 can supplement the supply of autonomous vehicles within a geographic area with one or more non-autonomous vehicles. For instance, in the event that a vehicle imbalance persists within the first geographic area 410A, the operations computing system 300 can request that one or more non-autonomous vehicles (e.g., human-driven vehicles) be re-positioned to the first geographic area 410A. This can include non-autonomous vehicles that are online and/or offline with the service entity. For example, the operations computing system 300 can communicate data indicative of a re-positioning assignment 380 (shown in FIG. 3) to a user device associated with a non-autonomous vehicle 435. The re-positioning assignment 380 can request that an operator of the non-autonomous vehicle 435 re-position the non-autonomous vehicle 435 to the first geographic area 410A. The re-positioning assignment 380 can request that the non-autonomous vehicle 435 be re-positioned with respect to the first geographic area 410A. In some implementations, the re-positioning assignment 380 can include an incentive (e.g., a financial incentive, etc.) to entice the operator of the non-autonomous vehicle 435 to accept the re-positioning assignment 380. In some implementations, the re-positioning assignment 380 can request that the non-autonomous vehicle 435 be re-positioned away from the geographic area (e.g., to reduce vehicle supply in the event of a surplus), as further described herein.

In some implementations, the operations computing system 300 can de-activate one or more autonomous vehicles. Subsequent to obtaining data indicating that an autonomous vehicle is online with the service entity, the operations computing system 300 can determine that an autonomous vehicle is to go offline with the service entity. For instance, the operations computing system 300 can obtain data indicating that an autonomous vehicle associated with a particular vehicle provider is required to undergo maintenance. The operations computing system 300 can determine that these autonomous vehicles are to go offline with the service entity based at least in part on such information. The operations computing system 300 can communicate data (e.g., to the autonomous vehicles, a vehicle provider computing system, etc.) indicating that the autonomous vehicle(s) are to go offline with the service entity. In response, the autonomous vehicle can complete any current vehicle service assignments, go offline with the service entity (e.g., so that the autonomous vehicle can no longer obtain vehicle service assignments), and travel to a service depot, a based location, perform a pull-over maneuver, etc.

The operations computing system 300 can re-position more than one offline autonomous vehicle to more than one geographic area. For example, with reference to FIG. 4, the operations computing system 300 can determine a second geographic area 410B within which a second autonomous vehicle 405B is to go online with a service entity and a second time parameter 415B indicative of when the second autonomous vehicle 405B is to go online with the service entity based at least in part on the data 360 associated with the one or more autonomous vehicles and the data 365 associated with the one or more geographic areas. The operations computing system 300 can communicate data indicative of a second activation assignment associated with the second autonomous vehicle 405B. The second activation assignment can be indicative of at least a portion of the second geographic area 410B and the second time parameter 415B. For example, the second activation assignment can request that the second autonomous vehicle 405B re-position to (e.g., autonomously travel to) a second location 420B within the second geographic area 405B and go online with a service entity at a time indicated by the second time parameter 415B.

In some implementations, in the event of a surplus, the operations computing system 300 can decide that a vehicle should be moved away from a geographic area. For example, the first geographic area 410A (e.g., the airport facility) may experience a lower level of demand for vehicle services (e.g., a lower number of vehicle service requests). This can be outweighed by the supply of vehicles within the first geographic area 410A. As such, the operations computing system 300 can determine that an offline autonomous vehicle should be re-positioned away from the first geographic area 410A before it goes online with the service entity. For example, the operations computing system 300 can provide a vehicle activation assignment to an autonomous vehicle that requests that the autonomous vehicle be re-positioned to another geographic area (e.g., second geographic area 410B) prior to going online with a service entity. Additionally, or alternatively, the operations computing system 300 can communicate data indicative of a re-positioning assignment 380 to an online autonomous vehicle or non-autonomous vehicle that is within the first geographic area 410A. Such a re-positioning assignment 380 can indicate that the vehicle is to be re-positioned away from the first geographic area 410A.

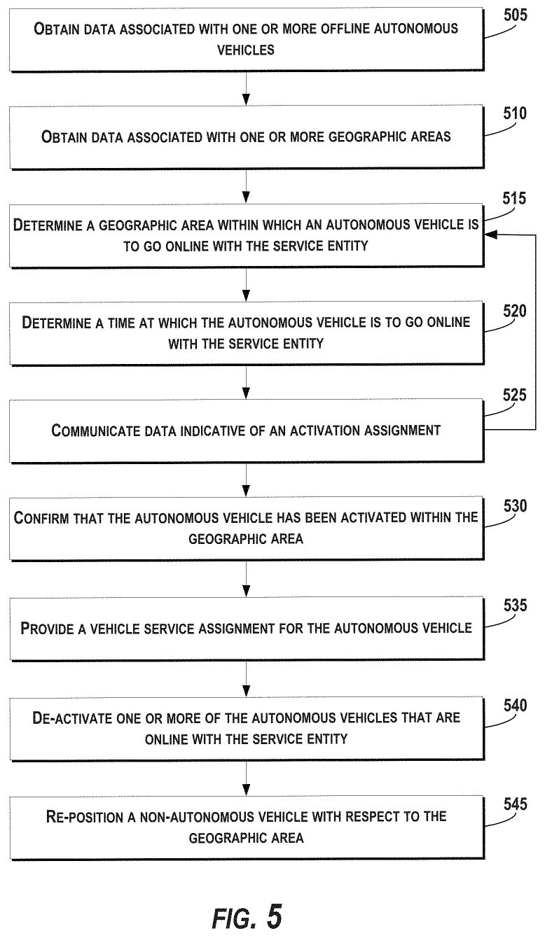

FIG. 5 depicts a flow diagram of an example method for controlling/re-positioning autonomous vehicles to reduce idle data usage and vehicle downtime according to example embodiments of the present disclosure. One or more portion(s) of the method 500 can be implemented by a computing system that includes one or more computing devices such as, for example, the computing systems described with reference to the other figures (e.g., an operations computing system 225A-B, 300, a vehicle provider computing system 210, 350, a vehicle computing system 100, 340, etc.). Each respective portion of the method 500 can be performed by any (or any combination) of one or more computing devices. Moreover, one or more portion(s) of the method 500 can be implemented as an algorithm on the hardware components of the device(s) described herein (e.g., as in FIGS. 1-3 and/or 6), for example, to control/re-position one or more autonomous vehicles. FIG. 5 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 5 is described with reference to elements/terms described with respect to other systems and figures for example illustrated purposes and is not meant to be limiting. One or more portions of method 500 can be performed additionally, or alternatively, by other systems.

At (505), the method 500 can include obtaining data associated with one or more offline autonomous vehicle(s). For instance, a first computing system (e.g., an operations computing system 300) can obtain data associated with one or more autonomous vehicles that are offline with a service entity. As described herein, an offline autonomous vehicle can be one that is not currently available to accept a vehicle service assignment, perform a vehicle service for the service entity, etc. The first computing system can obtain data associated with a plurality of autonomous vehicles that are offline with the service entity. As described herein, the data associated with the plurality of autonomous vehicles can include at least one of data indicative a preference of one or more vehicle services that each respective autonomous vehicle is configured to perform, data indicative of whether each respective autonomous vehicle is included in a dedicated or non-dedicated supply of the service entity, data indicative of one or more geographic constraints for each respective autonomous vehicle, data indicative of one or more vehicle characteristics for each respective autonomous vehicle, data indicative of a performance rating for each respective autonomous vehicle, data indicative of a location of each respective autonomous vehicle, or data indicative of a configured preference to perform vehicle service pooling of each respective autonomous vehicle.

At (510), the method 500 can include obtaining data associated with one or more geographic areas. For instance, the first computing system (e.g., the operations computing system 300) can obtain data associated with one or more geographic areas associated with the service entity. The geographic area(s) can be, for example, ones in which the service entity has offered, currently offers, and/or plans to offer vehicle services. The data associated with the geographic area(s) can include, for example, at least one of data indicative of a demand for one or more vehicle services associated with the geographic area, data indicative of a number of vehicles associated with the geographic area, data indicative of a utilization rate for the vehicles associated with the geographic area, data indicative of an event associated with the geographic area, or data indicative of a weather condition associated with the geographic area.

At (515), the method 500 can include determining a geographic area within which an autonomous vehicle is to go online with the service entity. For instance, the first computing system (e.g., the operations computing system 300) can determine a first geographic area within which a first autonomous vehicle is to go online with the service entity based at least in part on the data associated with the one or more autonomous vehicles and the data associated with the one or more geographic areas. The first computing system can select the first autonomous vehicle from among the plurality of autonomous vehicles based at least in part on the data associated with the plurality of autonomous vehicles. The geographic area may be predicted to have a vehicle imbalance. As described herein, the vehicle imbalance can include, for example, a deficit in the number of autonomous vehicles and/or non-autonomous vehicles available to perform one or more vehicle services within the first geographic area as compared to a demand for the one or more vehicles services within the first geographic area.

At (520), the method 500 can include determining a time at which the autonomous vehicle is to go online with the service entity. The first computing system (e.g., the operations computing system 300) can determine a first time parameter indicative of a time at which the first autonomous vehicle is to go online with the service entity based at least in part on the data associated with the one or more autonomous vehicles and the data associated with the one or more geographic areas. The first time parameter can be indicative of at least one of a future point in time at which the autonomous vehicle is to go online with the service entity or a future time period during which the autonomous vehicle is to go online with the service entity. The geographic area may be predicted to have a vehicle imbalance during at least one of the future point in time or the future time period.

At (525), the method 500 can include communicating data indicative of an activation assignment. For instance, the first computing system (e.g., the operations computing system 300) can communicate data indicative of a first activation assignment associated with the first autonomous vehicle. Such data can be communicated to a second computing system (e.g., a vehicle computing system, a vehicle provider computing system, etc.). As described herein, the first activation assignment can be indicative of at least a portion of the first geographic area and the first time parameter. For example, the first autonomous vehicle may be not located within the first geographic area (e.g., when it is determine that the first autonomous vehicle should be re-positioned). The first activation assignment can indicate that the first autonomous vehicle be re-positioned within the first geographic area prior to going online with the service entity. As such, the first autonomous vehicle can travel to the first geographic area and then go online with the service entity after arriving within the first geographic area.

In some implementations, the first computing system can repeat operations (515)-(525) to identify another autonomous vehicle for offline repositioning. For example, the first computing system (e.g., the operations computing system 300) can determine a second geographic area within which a second autonomous vehicle is to go online with the service entity and a second time parameter indicative of when the second autonomous vehicle is to go online with the service entity based at least in part on the data associated with the one or more autonomous vehicles and the data associated with the one or more geographic areas. The first computing system can communicate (e.g., to another computing system) data indicative of a second activation assignment associated with the second autonomous vehicle. The second activation assignment can be indicative of at least a portion of the second geographic area (e.g., to which the second autonomous vehicle is to travel) and the second time parameter.

At (530), the method 500 can include confirming that the autonomous vehicle has been activated within the geographic area. For instance, the first computing system (e.g., the operations computing system 300) can obtain data indicating that the first autonomous vehicle is online with the service entity and is located within the first geographic area, as described herein. Accordingly, at (535), the first computing system can communicate data indicative of a first vehicle service assignment for the first autonomous vehicle (e.g., to a vehicle computing system, vehicle provider computing system, etc.). The first vehicle service assignment can be indicative of a requested vehicle service (e.g., a transportation service) to be performed at least in part within the first geographic area.

In some implementations, at (540), the method 500 can include de-activating one or more of the autonomous vehicles that are online with a service entity. For instance, subsequent to obtaining data indicating that the first autonomous vehicle is online with the service entity, the first computing system (e.g., the operations computing system 300) can determine that the first autonomous vehicle is to go offline with the service entity (e.g., due to scheduled maintenance), as described herein. The first computing system can communicate data indicating that the first autonomous vehicle is to go offline with the service entity.

In some implementations, at (545), the method 500 can include re-positioning a non-autonomous vehicle with respect to a geographic area. For instance, the first computing system (e.g., operations computing system 300) can communicate data indicative of a re-positioning assignment to a user device associated with a non-autonomous vehicle associated with one or more vehicle services (e.g., a human driven vehicle online with the service entity to perform one or more vehicle services). The re-positioning assignment can request that the non-autonomous vehicle be re-positioned with respect to the first geographic area. For example, in the event of a vehicle deficit, the re-positioning assignment can request that the operator of the non-autonomous vehicle cause the non-autonomous vehicle to travel to the first geographic area. In the event of a vehicle surplus, the re-positioning assignment can request that the operator of the non-autonomous vehicle cause the non-autonomous vehicle to travel away from the first geographic area.

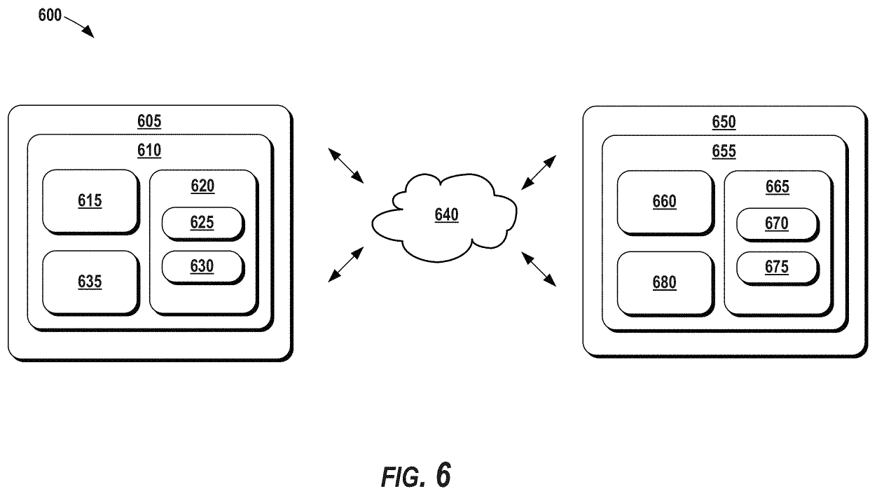

FIG. 6 depicts an example system 600 according to example embodiments of the present disclosure. The example system 600 illustrated in FIG. 6 is provided as an example only. The components, systems, connections, and/or other aspects illustrated in FIG. 6 are optional and are provided as examples of what is possible, but not required, to implement the present disclosure. The example system 600 can include a vehicle computing system 605 of a vehicle. The vehicle computing system 605 can represent/correspond to the vehicle computing systems 100, 340 described herein. The example system 600 can include a remote computing system 650 (e.g., that is remote from the vehicle computing system). The remote computing system 650 can represent/correspond to any of the operations computing systems (e.g., 225A-B, 300) described herein and/or the vehicle provider computing systems 210, 350 described herein. The vehicle computing system 605 and the remote computing system 650 can be communicatively coupled to one another over one or more network(s) 840.

The computing device(s) 610 of the vehicle computing system 605 can include processor(s) 615 and a memory 620. The one or more processors 615 can be any suitable processing device (e.g., a processor core, a microprocessor, an ASIC, a FPGA, a controller, a microcontroller, etc.) and can be one processor or a plurality of processors that are operatively connected. The memory 620 can include one or more non-transitory computer-readable storage media, such as RAM, ROM, EEPROM, EPROM, one or more memory devices, flash memory devices, data registrar, etc., and combinations thereof.

The memory 620 can store information that can be accessed by the one or more processors 615. For instance, the memory 620 (e.g., one or more non-transitory computer-readable storage mediums, memory devices) on-board the vehicle can include computer-readable instructions 625 that can be executed by the one or more processors 615. The instructions 625 can be software written in any suitable programming language or can be implemented in hardware. Additionally, or alternatively, the instructions 625 can be executed in logically and/or virtually separate threads on processor(s) 615.

For example, the memory 620 can store instructions 625 that when executed by the one or more processors 615 cause the one or more processors 615 (the vehicle computing system 605) to perform operations such as any of the operations and functions of the vehicle computing system 100 (or for which it is configured), one or more of the operations and functions of the vehicle provider computing systems (or for which it is configured), one or more of the operations and functions of the operations computing systems described herein (or for which it is configured), one or more of the operations and functions for controlling/re-positioning a vehicle, one or more of the operations and functions for determining that the vehicle should be re-positioned, one or more portions of method 500, and/or one or more of the other operations and functions of the computing systems described herein.

The memory 620 can store data 630 that can be obtained (e.g., acquired, received, retrieved, accessed, created, stored, etc.). The data 630 can include, for instance, sensor data, map data, vehicle state data, perception data, prediction data, motion planning data, data associated with a vehicle client, data associated with a service entity's telecommunications network, data associated with an API, data associated with a library, data associated with library parameters, data associated with vehicle service incentives, data associated with activation assignments, data associated with re-positioning assignments, data associated with vehicle service assignments, data associated with acceptances and/or rejections of activation assignments and/or vehicle service assignments, and/or other data/information such as, for example, that described herein. In some implementations, the computing device(s) 610 can obtain data from one or more memories that are remote from the vehicle computing system 605.

The computing device(s) 610 can also include a communication interface 635 used to communicate with one or more other system(s) on-board a vehicle and/or a remote computing device that is remote from the vehicle (e.g., of the system 650). The communication interface 635 can include any circuits, components, software, etc. for communicating via one or more networks (e.g., network(s) 640). The communication interface 835 can include, for example, one or more of a communications controller, receiver, transceiver, transmitter, port, conductors, software and/or hardware for communicating data.

The remote computing system 650 can include one or more computing device(s) 855 that are remote from the vehicle computing system 605. The computing device(s) 655 can include one or more processors 660 and a memory 665. The one or more processors 660 can be any suitable processing device (e.g., a processor core, a microprocessor, an ASIC, a FPGA, a controller, a microcontroller, etc.) and can be one processor or a plurality of processors that are operatively connected. The memory 665 can include one or more tangible, non-transitory computer-readable storage media, such as RAM, ROM, EEPROM, EPROM, one or more memory devices, flash memory devices, data registrar, etc., and combinations thereof.

The memory 665 can store information that can be accessed by the one or more processors 660. For instance, the memory 665 (e.g., one or more tangible, non-transitory computer-readable storage media, one or more memory devices, etc.) can include computer-readable instructions 670 that can be executed by the one or more processors 660. The instructions 670 can be software written in any suitable programming language or can be implemented in hardware. Additionally, or alternatively, the instructions 670 can be executed in logically and/or virtually separate threads on processor(s) 660.

For example, the memory 665 can store instructions 670 that when executed by the one or more processors 660 cause the one or more processors 660 to perform operations such as any of the operations and functions of the operations computing systems 225A-B, 300 described herein, any operations and functions of the vehicle provider computing systems, any of the operations and functions for which the operations computing systems and/or the vehicle computing systems are configured, one or more of the operations and functions of the vehicle computing system 100 described herein, one or more of the operations and functions for controlling a vehicle, one or more of the operations and functions for determining a vehicle for re-positioning, one or more portions of method 500, and/or one or more of the other operations and functions described herein.

The memory 665 can store data 675 that can be obtained. The data 675 can include, for instance, data associated with service requests, communications associated with/provided by vehicles, data to be communicated to vehicles, application programming interface data, data associated with vehicles, data associated with geographic areas, data indicative of vehicle imbalances, data associated with activation assignments data, data associated with re-positioning assignments, data associated with vehicle service incentives, data associated with vehicle service assignments, data associated with acceptances and/or rejections of activation assignments, re-positioning assignments, and/or vehicle service assignments, data associated with different service entities, data associated with fleet(s) of vehicles, and/or other data/information such as, for example, that described herein. In some implementations, the computing device(s) 655 can obtain data from one or more memories that are remote from the system 650 and/or are onboard a vehicle.

The computing device(s) 655 can also include a communication interface 680 used to communicate with one or more system(s) onboard a vehicle and/or another computing device that is remote from the system 650. The communication interface 680 can include any circuits, components, software, etc. for communicating via one or more networks (e.g., network(s) 640). The communication interface 680 can include, for example, one or more of a communications controller, receiver, transceiver, transmitter, port, conductors, software, and/or hardware for communicating data.

The network(s) 640 can be any type of network or combination of networks that allows for communication between devices. In some embodiments, the network(s) 640 can include one or more of a local area network, wide area network, the Internet, secure network, cellular network, mesh network, peer-to-peer communication link, and/or some combination thereof and can include any number of wired or wireless links. Communication over the network(s) 640 can be accomplished, for instance, via a communication interface using any type of protocol, protection scheme, encoding, format, packaging, etc.

Computing tasks, operations, and functions discussed herein as being performed at a vehicle (e.g., via the vehicle computing system) can instead be performed by computing device(s) that are remote from the vehicle (e.g., via a vehicle provider computing system, an operations computing system, etc.), and/or vice versa. Moreover, operations, and functions discussed herein as being performed at a service entity (e.g., via an operations computing system) can instead be performed by other computing device(s) such as, for example, those of the vehicle provider computing system, etc. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

The communications between computing systems described herein can occur directly between the systems or indirectly between the systems. For example, in some implementations, the computing systems can communicate via one or more intermediary computing systems. The intermediary computing systems may alter the communicated data in some manner before communicating it to another computing system.

The number and configuration of elements shown in the figures is not meant to be limiting. More or less of those elements and/or different configurations can be utilized in various embodiments.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computing system comprising:
one or more processors; and
one or more tangible, non-transitory, computer readable media that collectively store instructions that when executed by the one or more processors cause the computing system to perform operations comprising:
obtaining data associated with an autonomous vehicle that is offline with a service entity;
obtaining data associated with a geographic area associated with the service entity;
determining that the autonomous vehicle is to go online with the service entity within the geographic area based at least in part on the data associated with the autonomous vehicle and the data associated with the geographic area; and
communicating data indicative of an activation assignment associated with the autonomous vehicle, wherein the activation assignment is indicative of at least a portion of the geographic area within which the autonomous vehicle is to go online with the service entity.

2. The computing system of claim 1, wherein the autonomous vehicle is not located within the geographic area, and wherein the activation assignment indicates that the autonomous vehicle be re-positioned within the geographic area prior to going online with the service entity.

3. The computing system of claim 1, wherein the operations further comprise:
determining a time parameter based at least in part on the data associated with the autonomous vehicle and the data associated with the geographic area, wherein the time parameter is indicative of at least one of a point in time at which the autonomous vehicle is to go online with the service entity or a time period during which the autonomous vehicle is to go online with the service entity.

4. The computing system of claim 3, wherein determining that the autonomous vehicle is to go online with the service entity within the geographic area comprises:
predicting that the geographic area will have a vehicle imbalance during at least one of the point in time at which the autonomous vehicle is to go online with the service entity or the time period during which the autonomous vehicle is to go online with the service entity.

5. The computing system of claim 4, wherein the vehicle imbalance comprises a deficit in a number of vehicles available to perform one or more vehicle services as compared to a demand for the one or more vehicles services.

6. The computing system of claim 1, wherein the operations further comprise:
obtaining data indicating that the autonomous vehicle is online with the service entity and is located within the geographic area; and
communicating data indicative of a vehicle service assignment for the autonomous vehicle, wherein the vehicle service assignment is indicative of a requested vehicle service to be performed at least in part within the geographic area.

7. The computing system of claim 6, further comprising:
subsequent to obtaining data indicating that the autonomous vehicle is online with the service entity, determining that the autonomous vehicle is to go offline with the service entity; and
communicating data indicating that the autonomous vehicle is to go offline with the service entity.

8. The computing system of claim 1, wherein the data associated with the autonomous vehicle comprises at least one of data indicative of a preference of one or more vehicle services that the autonomous vehicle is configured to perform, data indicative of whether the autonomous vehicle is included in a dedicated or non-dedicated supply of the service entity, data indicative of one or more geographic constraints for the autonomous vehicle, data indicative of one or more vehicle characteristics for the autonomous vehicle, data indicative of a performance rating for the autonomous vehicle, data indicative of a location of the autonomous vehicle, or data indicative of a configured preference to perform vehicle service pooling by the autonomous vehicle.

9. The computing system of claim 1, wherein the data associated with the geographic area comprises at least one of data indicative of a demand for one or more vehicle services associated with the geographic area, data indicative of a number of vehicles associated with the geographic area, data indicative of a utilization rate for the vehicles associated with the geographic area, data indicative of an event associated with the geographic area, or data indicative of a weather condition associated with the geographic area.

10. A computer-implemented method for controlling autonomous vehicle activation, comprising:
obtaining, by a computing system that comprises one or more computing devices, data associated with one or more autonomous vehicles that are offline with a service entity;
obtaining, by the computing system, data associated with one or more geographic areas associated with the service entity;
determining, by the computing system, a first geographic area within which a first autonomous vehicle is to go online with the service entity and a first time parameter indicative of a time at which the first autonomous vehicle is to go online with the service entity based at least in part on the data associated with the one or more autonomous vehicles and the data associated with the one or more geographic areas; and
communicating, by the computing system, data indicative of a first activation assignment associated with the first autonomous vehicle, wherein the first activation assignment is indicative of at least a portion of the first geographic area and the first time parameter.

11. The computer-implemented method of claim 10, wherein the first autonomous vehicle is not located within the first geographic area, and wherein the first activation assignment indicates that the first autonomous vehicle be re-positioned within the first geographic area prior to going online with the service entity.

12. The computer-implemented method of claim 10, wherein the first time parameter is indicative of at least one of a future point in time at which the first autonomous vehicle is to go online with the service entity or a future time period during which the first autonomous vehicle is to go online with the service entity, and wherein the first geographic area is predicted to have a vehicle imbalance during at least one of the future point in time or the future time period.

13. The computer-implemented method of claim 12, wherein the vehicle imbalance comprises a deficit in a number of non-autonomous vehicles available to perform one or more vehicle services within the first geographic area as compared to a demand for the one or more vehicles services within the first geographic area.

14. The computer-implemented method of claim 10, wherein obtaining, by the computing system, data associated with one or more autonomous vehicles that are offline with the service entity comprises obtaining, by the computing system, data associated with a plurality of autonomous vehicles that are offline with the service entity;
wherein determining, by the computing system, the first geographic area within which the first autonomous vehicle is to go online with the service entity comprises selecting, by the computing system, the first autonomous vehicle from among the plurality of autonomous vehicles based at least in part on the data associated with the plurality of autonomous vehicles; and
wherein the data associated with the plurality of autonomous vehicles comprises at least one of data indicative a preference of one or more vehicle services that each respective autonomous vehicle is configured to perform, data indicative of whether each respective autonomous vehicle is included in a dedicated or non-dedicated supply of the service entity, data indicative of one or more geographic constraints for each respective autonomous vehicle, data indicative of one or more vehicle characteristics for each respective autonomous vehicle, data indicative of a performance rating for each respective autonomous vehicle, data indicative of a location of each respective autonomous vehicle, or data indicative of a configured preference to perform vehicle service pooling of each respective autonomous vehicle.

15. The computer-implemented method of claim 10, further comprising:
communicating, by the computing system, data indicative of a re-positioning assignment to a user device associated with a non-autonomous vehicle associated with one or more vehicle services, wherein the re-positioning assignment is indicative of a request that the non-autonomous vehicle be re-positioned with respect to the first geographic area.

16. The computer-implemented method of claim 10, further comprising:
determining, by the computing system, a second geographic area within which a second autonomous vehicle is to go online with the service entity and a second time parameter indicative of when the second autonomous vehicle is to go online with the service entity based at least in part on the data associated with the one or more autonomous vehicles and the data associated with the one or more geographic areas; and
communicating, by the computing system, data indicative of a second activation assignment associated with the second autonomous vehicle, wherein the second activation assignment is indicative of at least a portion of the second geographic area and the second time parameter.

17. One or more tangible, non-transitory, computer-readable media that collectively store instructions that, when executed by one or more processors, cause the one or more processors to perform operations, the operations comprising:
obtaining data associated with a plurality of autonomous vehicles that are offline with a service entity;
obtaining data indicative of a geographic area associated with the service entity;
determining that at least a subset of the plurality of autonomous vehicles are to go online with the service entity within the geographic area based at least in part on the data associated with the plurality of autonomous vehicle and the data indicative of the geographic area; and
communicating data indicative of one or more activation assignments associated with at least the subset of the plurality of autonomous vehicles, wherein the one or more activation assignments are indicative of at least a portion of the geographic area.

18. The one or more tangible, non-transitory, computer-readable media of claim 17, wherein the plurality of autonomous vehicles are associated with a vehicle provider, and wherein communicating the data indicative of the one or more activation assignments comprises communicating the data indicative of the one or more activation assignments to a computing system associated with the vehicle provider.

19. The one or more tangible, non-transitory, computer-readable media of claim 17, wherein the one or more activation assignments are indicative of a request for at least the subset of autonomous vehicles to re-position within the geographic area prior to going online with the service entity within the geographic area.

20. The one or more tangible, non-transitory, computer-readable media of claim 17, wherein the one or more activation assignments are indicative of a vehicle service incentive associated with the re-positioning of the subset of autonomous vehicles to the geographic area.
